(19) United States
(12) Patent Application Publication
(10) Pub. No.: US 2026/0212376 A1
(43) Pub. Date: Jul. 23, 2026

(54) Systems and Methods for Geometric Modeling of Customer Behavior and Responses to Marketing Stimuli

(71) Applicant: Pelatro Pte, Ltd,, Singapore (SG)

(72) Inventors: Arun Kumar Krishna, Banaswadi (IN); Pramod Konandur Prabhakar, Banaswadi (IN)

(21) Appl. No.: 19/032,237

(22) Filed: Jan. 20, 2025

Related U.S. Application Data
(60) Provisional application No. 63/616,074, filed on Dec. 29, 2023.

(51) Int. Cl. G06Q 30/0202

(52) U.S. Cl. CPC G06Q 30/0202

(57) ABSTRACT

A computerized system and method for conic-based marketing analytics and predictive modelling to analyze and optimize marketing activities within large enterprises. The system employs quantitative geometric modeling techniques to represent marketing objectives as right circular cones, where parameters such as time, velocity, and area characterize customer journeys. Using a Conics Model (CM), the system clusters subscribers based on their conic profiles and additional behavioral attributes, enabling granular insights into the effectiveness of marketing strategies. The system incorporates reinforcement learning to build a dynamic knowledge base, capturing the evolving impact of marketing activities on subscriber behavior over time. Additionally, a hypothesis-driven marketing activity synthesis workbench provides business users with a powerful tool to design, simulate, and refine marketing strategies using insights derived from the knowledge base. Various visual representations at a customer-focused level in order to identify and predict customer behavior based on marketing efforts and effects.

### CROSS REFERENCE TO RELATED APPLICATIONS

To the full extent permitted by law, the present United States Non-Provisional patent application hereby claims priority to and the full benefit of, U.S. Provisional Application No. 63/616,074, filed Dec. 29, 2023, entitled “Quantitative techniques to study marketing responses to various actions and inactions by mapping them to conics, discover stimulation triggers and focal points of significance for different behavioral traits, and then propose new actions, stimulants, and behaviors (Tarka)”, which is incorporated herein by reference in its entirety.

### FIELD OF THE DISCLOSURE

The present disclosure is directed to organization of user-relevant data in connection with product and services offerings and utilization.

More specifically, the disclosure is directed to the collection, organization, and geometric modelling of real time user data to determine appropriate means, mechanisms, and efforts thereof to prescribe and/or predict the influence thereof on user behavior.

The present disclosure is not limited to any specific file management system, user or customer type, database structure, physical computing infrastructure, enterprise resource planning (ERP) system/software/service, computer code language, or services offering.

### BACKGROUND OF THE DISCLOSURE

Businesses in various industries, including, by way of example and not limitation, telecommunications, financial services, online retail, social media, publishers, and other large-scale consumer-focused sectors often engage with vast customer bases that span hundreds of millions of subscribers. These interactions generate immense volumes of structured and/or semi-structured data, arising from diverse customer touchpoints such as product inquiries, purchases, customer support interactions, marketing campaigns, and other business-customer engagements. For such enterprises, this data constitutes a critical asset that can inform strategies to improve personalization, customer engagement, and revenue generation. However, leveraging data streams containing such voluminous information effectively and/or efficiently may often present a host of technical challenges, especially those which relate to mapping customer behavior and marketing activity into actionable insights across such large customer bases, modelling customer journeys, and targeting customers for marketing campaigns which are both effective to influence customer behavior and to avoid any customer backlash and/or negative reaction thereto.

One core challenge may lie in simultaneously understanding the relationship between marketing efforts and their effects over time at the macro (aggregate), a subset thereof as may be variously defined herein, and micro (individual customer and/or cluster) levels. While traditional marketing systems often focus on tracking discrete customer actions (e.g., campaign responses, purchases), they may often lack the ability to cohesively model dynamics of how efforts (e.g., outreach, incentives) interact with effects (e.g., customer actions) within the broader context of customer journeys as customers progress toward (or away from) business goals. Such journeys encompass a wide range of customer states, from initial interest in a business's offering to long-term loyalty and even evangelism, often marked by personalized behaviors and evolving needs. Businesses seeking to build a “segment of one” strategy—where marketing is customized for individual customers—face unique challenges in organizing and analyzing these interactions, particularly in real time and at scale across interactions and customers at such great volumes.

Some previous attempts to address these challenges may have utilized customer relationship management (CRM) systems and other data-driven platforms to track and analyze customer behavior. While these systems can generate reports and segment customers based on historical data, they often fall short of creating dynamic, real-time models that account for the complexity and variability of customer journeys. As those of ordinary skill in the art may understand, these limitations of these systems may often include fragmented views of customer engagement, inability to handle personalization at scale, lack of predictive capabilities, and inability to visualize customer journeys and customer behavior at both scale and on an individualized basis. Briefly, at least as it relates to fragmentation, many systems cannot integrate diverse data sources from multiple channels (e.g., web, in-store, mobile) to provide a holistic perspective of a customer journey. As it may relate to handling personalization at scale, strategies customized for smaller customer bases or clusters of customers having specific buying and/or consumption behavior often fail when applied to enterprises with hundreds of millions of subscribers, leading to generalized insights rather than tailored recommendations, or ill-fitting tailored strategies wasted upon such larger populations. As it may relate to predictive capabilities, such traditional systems may lack tools to predict the outcomes of marketing efforts and adjust strategies dynamically.

More recent solutions have explored artificial intelligence (AI) and machine learning to address the shortcomings of traditional methods. These approaches often leverage clustering algorithms and predictive modeling to extract insights from customer data. However, they still face obstacles such as, for example, static and/or rule-based decision-making, inefficient data organization, and limited ability to learn from valuable experimentation. As it may relate to decision-making, AI-based solutions, which often rely on pre-defined frameworks, may limit their ability to discover non-intuitive patterns or adapt to evolving customer behavior. Inefficient data organization in these systems might mean that their structuring and visualization of customer data cannot adequately represent the complex interplay of marketing activities and customer responses, at least in a manner which can provide real-time relevant insights without overwhelming computing resources or requiring excessive capabilities thereof. Then, as it may relate to experimentation, few AI systems can provide robust frameworks for designing and testing marketing hypotheses based on real-time data due to difficulties known to exist relating to how an artificial intelligence system arrives at various conclusions/decisions.

Further exacerbating these limitations may be the lack of a unified approach for mapping marketing objectives and their results into an interpretable, reusable framework. Many existing systems fail to connect subscriber-level marketing activities to broader, behavioral clusters in a meaningful, systematic manner, leaving gaps in the ability to generalize insights or apply them at scale. For example, they may lack a geometric data representation, pose difficulty in addressing diverse customer behaviors, provide limited tools for deriving actionable insights both over time and in real time, be inefficient in testing and refining marketing hypotheses, and insufficiently adapt to knowledge bases (existing or generated). As it may relate to lack of a geometric data representation, existing AI solutions may lack mechanisms for translating marketing activities and outcomes into a structured geometric model. Such geometric models, if implemented, could serve as a powerful visual and analytical tool for identifying trends, relationships, and areas of improvement in marketing efforts by linking real-world and real-time behaviors to geometric representations, which may be more readily understood by both such AI systems and humans investigating these actions/results. When it comes to difficulty in addressing diverse customer behaviors, marketing campaigns like these may often aim to serve highly variable subscriber behaviors, and existing clustering methods cannot robustly represent or adapt to complex, dynamic population-level responses, at least with respect to the urgency such decision-making might be necessary to accurately demonstrate success in influencing customer behavior. This limitation might present additional difficulty as it relates to how businesses to design campaigns that account for emergent behavior patterns or evolving customer journeys and act upon such patterns via automated mechanisms (e.g., marketing messages transmitted based on real-time behaviors and decision-making related thereto). As it may relate to existing tools for deriving actionable insights from intrinsic properties of data representations, even when data clustering methods might be deployed, there may often be little-to-no emphasis on leveraging mathematical properties (such as symmetry, focal points, or axes) to extract key marketing insights, leaving potentially valuable connections unexplored. With regard to these systems' inefficiency in testing and refining marketing hypotheses, conventional AI systems without geometric representation mechanisms may struggle with the iterative design of marketing experiments or the synthesis of entirely new strategies. Lacking a dynamic feedback loop informed by historical and current data, these systems can fall short in enabling businesses to predict and optimize future actions effectively and in time to reliably influence the same. Finally, at least as it may relate to existing AI frameworks, insufficient adaptability of knowledge bases can mean failure to construct adaptive and context-aware knowledge bases that evolve alongside customer behavior, leaving significant untapped potential for reinforcement learning techniques to drive better marketing outcomes.

Recognizing these limitations, there is a need for a system that not only resolves these obstacles but also provides a cohesive, scalable, and mathematically rigorous framework for mapping, clustering, and analyzing marketing activities and their outcomes. A new conics model can represent one such approach in order to address these technical challenges by combining geometric modeling, advanced clustering techniques, and reinforcement learning to optimize and scale marketing strategies across large subscriber bases. By leveraging the intrinsic properties of conic sections and mapping subscriber behaviors to specific geometric constructs, the disclosure creates an innovative system for understanding, segmenting, and personalizing marketing efforts. Therefore, a need exists to provide a technical solution to such highly technical business-quantitative techniques in order to study marketing responses to various actions (and inactions) by mapping them to conics, discover stimulation triggers and focal points of significance for different behavioral traits, and then propose new actions, stimulants, and behaviors. This disclosure addresses these challenges by providing a unified approach that encompasses all these aspects, offering a superior solution compared to previous attempts. The disclosed system and method may accomplish this feat by offering a unique combination of features, including a proposed Conics Model (CM), which may include mapping of net status of marketing activities into a point on the surface of the cone and approximating plane fitting capturing optimal points marked along the surface of the plane. Additional features which are described in detail herein may include clustering methods based on this CM, highly concise and efficient data mapping/schema thereof, emphasis of certain features of the CM and corresponding curves/shapes corresponding thereto a planar intersection thereof (e.g., ellipses and their foci, parabolas and their directrix), reinforcement learning techniques based on a CM knowledgebase, and marketing activity hypothesis(es)/synthesis(es)/generative mode(s) in order to provide a full assembly of tools and methods to accurately reflect customer journeys, clusters, and effectively plan and act upon stimuli thereto.

### SUMMARY OF THE DISCLOSURE

The present disclosure addresses the aforementioned limitations of conventional marketing systems by introducing systems and methods for geometric modeling of customer behavior and responses to marketing stimuli. Such systems and methods overall may be understood to include a novel conics model (CM), which may organize marketing objectives, customer behaviors, and their effects into a robust geometric framework. The disclosed systems and methods for geometric modeling of customer behavior and responses to marketing stimuli may further include systems and methods for mapping marketing activities to cones, including right circular cones, that represent the complex interplay between marketing efforts (i.e., stimuli) and effects (i.e., customer responses) in customer-centric enterprises. By classifying subscriber interactions along the surface of a cone, segmenting customers into behavioral clusters using conic sections, and building a reinforcement learning-driven knowledge base, the disclosed systems and methods for geometric modeling of customer behavior and responses to marketing stimuli may offer unprecedented insights into marketing dynamics, customer behavior, and campaign optimization, in real time and without machine resources becoming exhausted and/or overused.

These systems and methods for geometric modeling of customer behavior and responses to marketing stimuli may achieve their objectives by leveraging the intrinsic mathematical properties of conic sections, which may include circles, ellipses, parabolas, and hyperbolas, which may in turn enable modeling, analyzation, and prediction of customer responses to marketing activities. The disclosed systems and methods for geometric modeling of customer behavior and responses to marketing stimuli may further enable clustering based on such conic sections, with additional dimensions such as surface area, peak height, and key geometric attributes of the conics to generalize cluster behaviors. Such geometric representation(s) can then be extended to real-time hypothesis(es) testing and the synthesis of new marketing strategies, driven by a self-learning knowledge base.

In at least one aspect, the disclosed systems and methods for geometric modeling of customer behavior and responses to marketing stimuli can provide a comprehensive framework for modeling marketing objectives for individual subscribers or microsegments into a (right circular) cone with discrete steps tapering toward the apex (i.e., peak). Marketing activities and their effects may be mapped as points along the surface of the cone, enabling an approximation of a best-fit plane to represent the majority of marketing interactions/stimuli, with a configurable tolerance for error. The resultant intersection between the cone and the plane may yield a conic section, which can in turn serve as a foundation for clustering subscribers into behavioral groups.

In another aspect, the clustering process of the disclosed systems and methods for geometric modeling of customer behavior and responses to marketing stimuli may be enhanced by incorporating additional parameters, such as the surface area under the conic section and the height of the conic apex. Subscribers can be categorized into one of, e.g., 64 pre-defined clusters, each representing a distinct behavioral archetype, enabling businesses to uncover patterns and outliers in their customer base. Key points of emphasis, such as the center of a circle, foci of an ellipse, or the directrix of a parabola, can then be reliably identified for each conic section to derive actionable marketing insights.

In yet another aspect, the disclosed systems and methods for geometric modeling of customer behavior and responses to marketing stimuli can include the reinforcement learning-based knowledge base, which may be understood to capture the impact of marketing activities on subscribers in real-time. By analyzing the geometric properties of the cone, the slope of recent changes, and the movements of points within the conic structure, the knowledge base can be enabled to accumulate action-consequence relationships. The resultant knowledge base may then be capable of new hypothesis generation as well as inform marketing strategy design, which can support businesses in identifying proposed experiments, running them, optimizing campaign/experiments in real-time, and synthesizing/suggesting new or appropriate activities/approaches/stimuli for improving outcomes.

In other aspects, the proposed systems and methods for geometric modeling of customer behavior and responses to marketing stimuli may include certain tools and/or dashboards, which may be understood as a marketing activity hypothesis and synthesis workbench. Such tools may leverage the resulting knowledge base summarized above to support decision-making through a dual-mode approach: (1) a decision tree framework for evaluating hypotheses and (2) an expectation maximization algorithm for generative synthesis of novel marketing strategies. Such an iterative workbench can empower business-end and/or marketing professional users to refine existing campaigns, design “what-if” scenarios for hypothesis testing, and execute such data-driven marketing experiments with precision and adaptability. Related thereto such aspects, the systems and methods of the disclosure may further include a graphical user interface (GUI) or dashboard for visualizing conic sections, behavioral clusters, and marketing outcomes, providing businesses with an intuitive tool for monitoring, planning, and adjusting their strategies. By integrating these features, the systems and methods of the disclosure can support businesses in achieving marketing personalization at scale, fostering customer loyalty and even evangelism, and which may be likely to drive revenue growth through data-driven marketing strategies. Other visual outputs and/or GUI may include individualized representations of customers (or clusters thereof) as colorized artwork, at least one of which may include a circle subdivided into segments which are “filled” according to properties which may correspond along variables, as described in detail herein and exemplified in the color Drawing provided herewith.

Overall, the systems and methods for geometric modeling of customer behavior and responses to marketing stimuli as disclosed herein may offer significant advantages over existing systems, including but not limited to enablement of modelling marketing data as geometric constructs to facilitate extensive analysis and optimization, providing tools for behavioral clustering using conic sections using well-defined mathematical bases for understanding customer behavior, leveraging fundamental properties of conic sections to derive actionable business insights, building reinforcement learning knowledge base(s) for designing and testing marketing hypotheses at scale, and automating the synthesis of new/appropriate/effective marketing activities to enable businesses to maximize business objectives over time and on a timely basis.

By addressing the shortcomings of the prior art attempts at solving the above problems and by offering a unified framework for modeling, clustering, and optimizing marketing activities, the proposed systems and methods for geometric modeling of customer behavior and responses to marketing stimuli represent a significant advancement in the art of modeling and clustering customer behavior. Through the disclosed systems and methods for geometric modeling of customer behavior and responses to marketing stimuli, combinations of geometric modeling, adaptive learning, and hypothesis-driven experimentation are enabled to equip businesses with tools to achieve superior customer engagement and sustained growth. The following Detailed Description and accompanying Drawings further illustrate the features and benefits of the disclosed systems and methods for geometric modeling of customer behavior and responses to marketing stimuli, providing comprehensive insights into its operation and implementation, which may be further adapted/configured by those having ordinary skill in the art wishing to better understand such interactions in real time and via such disclosed knowledge bases.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIGS. 1A-B are a block diagrams of computer and networking systems of the present disclosure;

FIGS. 2A-B are block diagrams of exemplary B2C communication/interaction systems of the disclosure;

FIGS. 3A-D illustrate geometric principles, including conic structures, cross-sections, and spiral patterns, as applied to modeling customer behavior and responses to marketing stimuli;

FIGS. 4A-B depict customer journey modeling, including trail-to-walk deduction processes and approximations of customer journeys through mathematical and geometric representations;

FIG. 4C provides an arbitrary example illustrating geometric calculations and modeling techniques for customer behavior on a conic surface, based on the principles illustrated and described in relation to FIGS. 4A-B;

FIGS. 5A-D show various conic structures, classifications, clustering techniques, and decisioning steps for selecting spiral paths and analyzing customer behaviors;

FIGS. 6A-B illustrate conic segmentation and circular planes for modeling customer behavior and effort-effect relationships;

FIG. 7 details a quadrant of a marketing circle, segmented into bands and radials to represent customer engagement trends and classifications;

FIGS. 8A-C present curve encoding schema and bitwise address arrangements for efficient storage and analysis of customer journey data;

FIG. 9 illustrates exemplary customer journey color artwork for visualizing customer data in a human-readable and machine-interpretable format;

FIG. 10 demonstrates a spiral electorate method for selecting optimal spiral paths based on geometric modeling of customer behavior; and

FIG. 11 illustrates a multi-step method for geometric modeling of customer behavior and responses to marketing stimuli, including data initialization, spiral synthesis, plane fitting, and knowledge base utilization.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

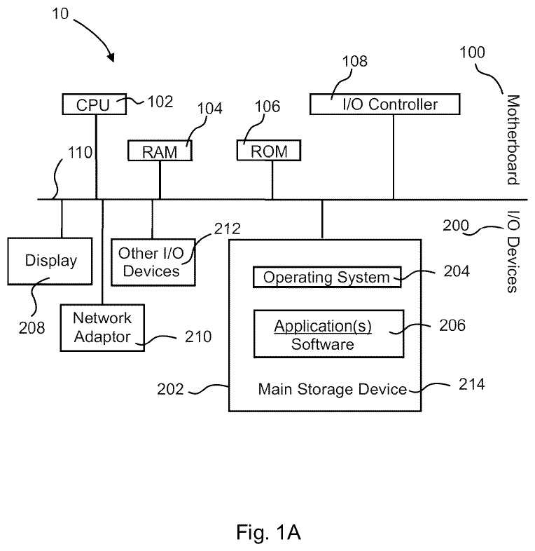

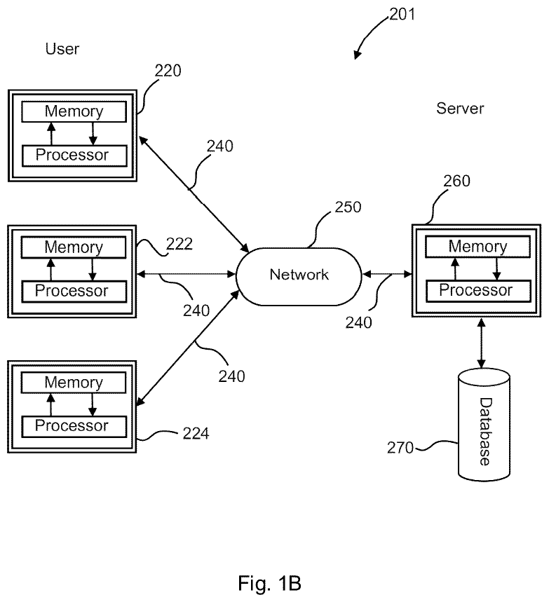

Referring now to FIGS. 1-11, in describing the exemplary embodiments of the present disclosure, specific terminology is employed for the sake of clarity. Certain terms, as they may be relevant to the quantitative assessment of user and subscriber behaviors as well as business actions to elicit certain behaviors may be defined as follows. An interaction may mean any distinct/discrete touchpoint between a user/subscriber and a business at a specific time, though potentially with a plurality of purposes to achieve a business objective. Such interaction could come in many varieties, including an informational message, a phone call, a coupon, an offer for a new service addition, the like and/or combinations thereof. Engagement may mean a group of interactions having some cohesivity toward a business objective. A micro-journey may mean any activity experienced and/or performed by a user/subscriber which has a purpose in the mind of the user/subscriber. A journey may mean the interactions, engagements, micro-journeys, and other events between the user and business as may be observed by the business toward one or more business objectives. The present disclosure may use the terms customer, user, subscriber, consumer, and advocate interchangeably, and the disclosure is not so limited to those which an individual pays or otherwise financially rewards a business for provision of products and/or services, which may also be used interchangeably herein. Additionally, as may be important to the mathematical and trigonometric features of the disclosure, certain conventions for the naming of certain geometric shapes, including but not limited to triangles, cones, and sections thereof may be observed, omitted and/or not included for purposes such as emphasis upon a specific angle, side, or other feature of such triangles and/or cone, or sections thereof. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

The present disclosure solves the aforementioned limitations of the currently available devices, computerized systems, and methods thereof for collecting, organizing, and curating customer engagements across multiple domains to provide contextual nurturing and alignment of customer journeys to business objectives, by providing systems and methods for geometric modeling of customer behavior and responses to marketing stimuli.

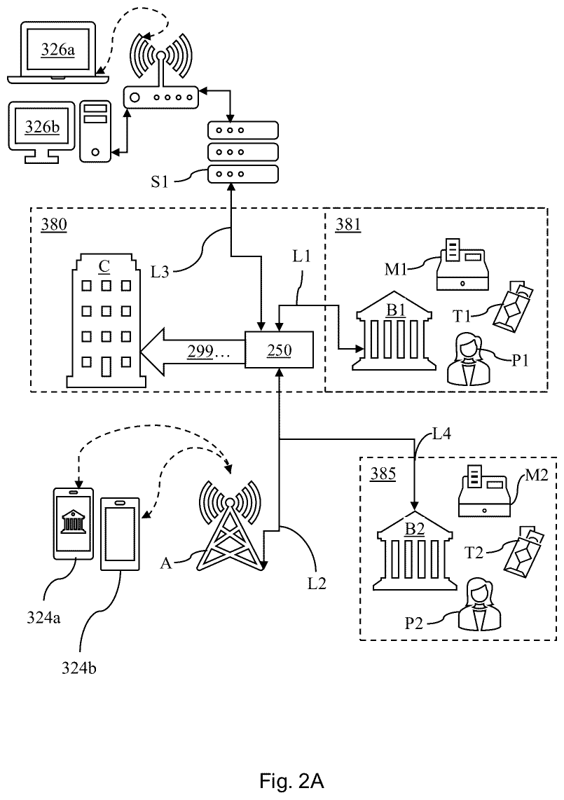

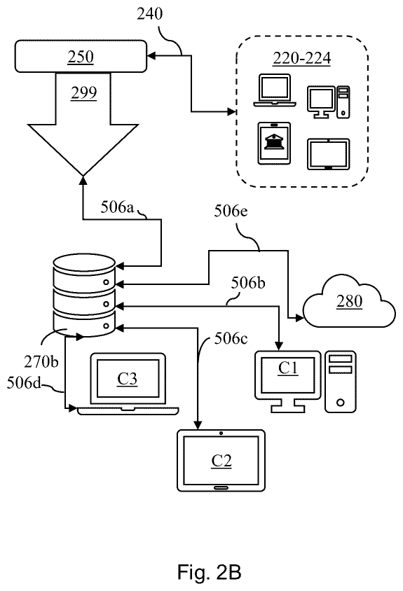

In describing the exemplary embodiments of the present disclosure, as illustrated in FIGS. 1A-1B. specific terminology is employed for the sake of clarity. The present disclosure, however, is not intended to be limited to the specific terminology so selected, and it is to be understood that each specific element includes all technical equivalents that operate in a similar manner to accomplish similar functions. The claimed invention may, however, be embodied in many different forms and should not be construed to be limited to the embodiments set forth herein. The examples set forth herein are non-limiting examples, and are merely examples among other possible examples. It should further be noted that with respect to FIGS. 1A-1B, FIGS. 2A-2B, as well as other Drawings of the disclosure, vast simplification of these techniques may be described herein in order to succinctly demonstrate various features of the disclosure, but applicability to larger, vastly more complicated systems may be achieved by those having ordinary skill in the art using other steps, features, systems, methods, and techniques as may be disclosed herein and/or known and understood by those having ordinary skill in the art.

As will be appreciated by one of such skill in the art, the present disclosure may be embodied as a method, data processing system(s), software as a service (SaaS), computer program product(s), artificial intelligence system(s), large language model(s), the like and/or combinations thereof. Accordingly, the present disclosure may take the form of an entirely hardware embodiment, an entirely software embodiment or an embodiment combining software and hardware aspects in order to solve the various technical problems with the various technical solutions as may be disclosed herein. Furthermore, the present disclosure may take the form of a computer program product on a computer-readable storage medium having computer-readable program code means embodied in the medium. Any suitable computer readable medium may be utilized, including hard disks, ROM, RAM, CD-ROMs, electrical, optical, magnetic storage devices and the like.

The present disclosure is described below with reference to block and flowchart illustrations of methods, apparatus (systems) and computer program products according to embodiments of the present disclosure. It will be understood that each block or step of the flowchart illustrations, and combinations of blocks or steps in the flowchart illustrations, can be implemented by computer program instructions or operations, which may occur on one device or many. These exemplary computer program instructions, functions, equations, and/or operations may be loaded onto a general-purpose computer, special purpose computer, server, networks thereof and/or other programmable data processing apparatus to produce a machine, such that the instructions or operations, which execute on the computer or other programmable data processing apparatus(es), create means for implementing the functions specified in the flowchart block or blocks/step or steps.

These computer program instructions or operations may also be stored in a computer-usable memory that can direct a computer or other programmable data processing apparatus to function in a particular manner, such that the instructions or operations stored in the computer-usable memory produce an article of manufacture including instruction means which implement the function specified in the flowchart block or blocks/step or steps. The computer program instructions or operations may also be loaded onto a computer or other programmable data processing apparatus (processor) to cause a series of operational steps to be performed on the computer or other programmable apparatus (processor) to produce a computer implemented process such that the instructions or operations which execute on the computer or other programmable apparatus (processor) provide steps for implementing the functions specified in the flowchart block or blocks/step or steps. Accordingly, blocks or steps of the flowchart illustrations support combinations of means for performing the specified functions, combinations of steps for performing the specified functions, and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions or operations.

Computer programming for implementing the present disclosure may be written in various programming languages, database languages, the like and/or combinations thereof. However, it is understood that other source or object-oriented programming languages, and other conventional programming language may be utilized without departing from the spirit and intent of the present disclosure.

Referring now to FIG. 1A specifically, there is illustrated a block diagram of a simplified computing system 10 that provides a suitable environment for implementing embodiments of the present disclosure. The computer architecture shown in FIG. 1A, as may be well understood by those having ordinary skill in the art, is divided into two parts—motherboard 100 and the input/output (I/O) devices 200. Motherboard 100 preferably includes subsystems and/or processor(s) to execute instructions such as central processing unit (CPU) 102, a memory device, such as random-access memory (RAM) 104, input/output (I/O) controller 108, and a memory device such as read-only memory (ROM) 106, also known as firmware, which are interconnected by bus 110. A basic input output system (BIOS) containing the basic routines that help to transfer information between elements within the subsystems of the computer is preferably stored in ROM 106, or operably disposed in RAM 104. Computing system 10 further preferably includes I/O devices 202, such as main storage device 214 for storing operating system 294 and instructions or application program(s) 206, and display 208 for visual output, and other I/O devices 212 as appropriate. Main storage device 214 preferably is connected to CPU 102 through a main storage controller (represented as 108) connected to bus 110. Network adapter 210 allows the computer system to send and receive data through communication devices or any other network adapter capable of transmitting and receiving data over a communications link that is either a wired, optical, or wireless data pathway. It is recognized herein that central processing unit (CPU) 102 performs instructions, operations or commands stored in ROM 106 or RAM 104.

Processor 102 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1A as a single processor, in some embodiments, processor 102 comprises a plurality of processors. The plurality of processors may be embodied on a single computing device or may be distributed across a plurality of computing devices collectively configured to function as the computing device 10. The plurality of processors may be in operative communication with each other and may be collectively configured to perform one or more functionalities of the computing device 10 as described herein. In an example embodiment, processor 102 is configured to execute instructions stored in memory 104, 106 or otherwise accessible to processor 102. These instructions, when executed by processor 102, may cause the computing device 10 to perform one or more of the functionalities of the computing device 10 as described herein.

Whether configured by hardware, firmware/software methods, or by a combination thereof, processor 102 may comprise an entity capable of performing operations according to embodiments of the present invention while configured accordingly. Thus, for example, when processor 102 is embodied as an ASIC, FPGA or the like, processor 102 may comprise specifically configured hardware for conducting one or more operations described herein. As another example, when processor 102 is embodied as an executor of instructions, such as may be stored in memory 104, 106, the instructions may specifically configure processor 102 to perform one or more algorithms and operations described herein.

The plurality of memory components 104, 106 may be embodied on a single computing device 10 or distributed across a plurality of computing devices. In various embodiments, memory may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 104, 106 may be configured to store information, data, applications, instructions, or the like for enabling the computing device 10 to carry out various functions in accordance with example embodiments discussed herein. For example, in at least some embodiments, memory 104, 106 is configured to buffer input data for processing by processor 102. Additionally or alternatively, in at least some embodiments, memory 104, 106 may be configured to store program instructions for execution by processor 102. Memory 104, 106 may store information in the form of static and/or dynamic information. This stored information may be stored and/or used by the computing device 10 during the course of performing its functionalities.

Many other devices or subsystems or other I/O devices 212 may be connected in a similar manner, including but not limited to, devices such as microphone, speakers, flash drive, CD-ROM player, DVD player, printer, main storage device 214, such as hard drive, and/or modem each connected via an I/O adapter. Also, although preferred, it is not necessary for all of the devices shown in FIG. 1A to be present to practice the present disclosure, as discussed below. Furthermore, the devices and subsystems may be interconnected in different configurations from that shown in FIG. 1A, or may be based on optical or gate arrays, or some combination of these elements that are capable of responding to and executing instructions or operations. The operation of a computer system such as that shown in FIG. 1A is readily known in the art and is not discussed in further detail in this application, so as not to overcomplicate the present disclosure with unnecessary recitations of well-known computing technologies.

In some embodiments, some or all of the functionality or steps may be performed by processor 102. In this regard, the example processes and algorithms discussed herein can be performed by at least one processor 102. For example, non-transitory computer readable storage media can be configured to store firmware, one or more application programs, and/or other software, which include instructions and other computer-readable program code portions that can be executed to control processors of the components of system 201 to implement various operations, including the examples shown above. As such, a series of computer-readable program code portions may be embodied in one or more computer program products and can be used, with a computing device, server, and/or other programmable apparatus, to produce the machine-implemented processes discussed herein.

Any such computer program instructions and/or other type of code may be loaded onto a computer, processor or other programmable apparatuses circuitry to produce a machine, such that the computer, processor or other programmable circuitry that executes the code may be the means for implementing various functions, including those described herein.

Referring now to FIG. 1B, there is illustrated a diagram depicting an exemplary system 201 in which concepts consistent with the present disclosure may be implemented or performed. Examples of each element within the communication system 201 of FIG. 1B are broadly described above with respect to FIG. 1A. In particular, the server system 260 and user system 220 have attributes similar to computer system 10 of FIG. 1A and illustrate one possible implementation of computer system 10. Communication system 201 preferably includes one or more user systems 220, 222, 224, one or more server system 260, and network 250, which could be, for example, the Internet, public network, private network or cloud. User systems 220-224 each preferably include a computer-readable medium, such as random-access memory, coupled to a processor. The processor, CPU 102, executes program instructions or operations stored in memory. Communication system 201 typically includes one or more user system 220. For example, user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a digital camera, a component, other equipment, or some combination of these elements that is capable of responding to and executing instructions or operations.

Similar to user system 220, server system 260 preferably includes a computer-readable medium, such as random-access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1A. Server system 260 may additionally include a secondary storage element, such as database 270 for storage of data and information. Server system 260, although depicted as a single computer system, may be implemented as a network of computer processors. Memory in server system 260 contains one or more executable steps, program(s), algorithm(s), or application(s) 206 (shown in FIG. 1A). For example, the server system 260 may include a web server, information server, application server, one or more general-purpose computers (e.g., personal computers), one or more special purpose computers (e.g., devices specifically programmed to communicate with each other), a workstation or other equipment, or some combination of these elements that is capable of responding to and executing instructions or operations.

System 201 is capable of delivering and exchanging data between user system 220 and a server system 260 through communications link 240 and/or network 250. Through user system 220, users can preferably communicate over network 250 with each other user system 220, 222, 224, and with other systems and devices, such as server system 260, to electronically transmit, store, manipulate, and/or otherwise use data exchanged between the user system and the server system. Communications link 240 typically includes network 250 making a direct or indirect communication between the user system 220 and the server system 260, irrespective of physical separation. Examples of a network 250 include the Internet, cloud, analog or digital wired and wireless networks, radio, television, cable, satellite, and/or any other delivery mechanism for carrying and/or transmitting data or other information, such as to electronically transmit, store, manipulate, and/or otherwise modify data exchanged between the user system and the server system. The communications link 240 may include, for example, a wired, wireless, cable, optical or satellite communication system or another pathway. It is contemplated herein that RAM 104, main storage device 214, and database 270 may be referred to herein as storage device(s) or memory device(s).

With respect to FIG. 2A, therein illustrated is a block chart of an exemplary intake ingestion scheme of an exemplary telecommunication network and a computerized services infrastructure, which may access or be in receipt of certain financial data, social media data, entertainment data, or other networks' data via datastream 299 as may be herein described and/or recognized by those having ordinary skill in the art, and may be described in a basic exemplary embodiment in FIG. 2A. Basic components, which may or may not be required depending on the users/systems/subscribers/customers/content being monitored, studied, or stored, are exemplary only. A system and method according to the disclosure may be and likely is more complicated than may be illustrated in FIGS. 1A, 1B, 2A, 2B and otherwise, and may involve multiple (or numerous) towers, user devices, networks, servers, users, the like, and/or combinations thereof as may be understood by those having ordinary skill in the art. Beginning with various subscriber/user interaction(s) with various telecommunications and other computerized services infrastructure, first subscriber device 324a and second subscriber device 324b may each interact with antenna A (via wired or wireless connections), which may in turn transmit data and/or communicate via telecommunication line L2 with, for example, corporate servers C via network 250, which may or may not form a part of, for instance, the Internet, and other devices on network 250, which may reside on corporate network infrastructure 380, which may include exemplary database 270b, user systems 220, 222, 224 and agent systems C1-C3 (see FIG. 2B) via e.g., network lines 240 (see FIG. 1B) or communication links L1-L4. As may be understood by those having ordinary skill in the art, certain subscriber devices, such as e.g., first subscriber device 324a, may feature a mobile application configured to perform certain functions within the services domain of the business and communicate therewith via a credentialling system, which may be secure. Additionally, other user devices, such as laptop 326a, desktop 326b, and external server S1 may communicate similarly to network 250 and so on. Importantly, various branches of a business may operate via public and/or private networks to network 250, such as branch office B1 and branch office B2, which may feature among connected branch devices 381 and connected branch devices 385, respectively, through use of POS systems M1-M2, automated customer machines T1-T2, and branch associate machines P1-P2. Obviously, a high volume system, such as those designed to benefit from the disclosed system and method for collecting, organizing, and curating customer engagements across multiple domains to provide contextual nurturing and alignment of customer journeys to business objectives may be much more complicated than the elementary network examples provided herein, and may feature many hundreds or even millions of such exemplary devices as illustrated herein, and be connected via means known by those having ordinary skill in the art. By way of example and not limitation, such networks may take the form of private networks, virtual private networks, secure connections on the Internet or the Web, the like, and/or combinations thereof. These systems and the various communications and/or transactions thereof in communication with corporate servers C may obtain vast quantities of data via one or more of datastream 299, such that customer/user interactions may be received, stored, catalogued, analyzed, reported, and otherwise acted upon as may be herein described. The above communications and computerized services environment, at least with respect to the disclosed system and method for collecting, organizing, and curating customer engagements across multiple domains to provide contextual nurturing and alignment of customer journeys to business objectives, its features and benefits, and potential implementations may be even better understood by those having skill in the art from a review of the remaining FIGS. 2B-11, in addition to the accompanying Detailed Description.

Referring now specifically to FIG. 2B, therein illustrated is a block diagram of exemplary business-to-consumer (B2C) communication/interaction system of the disclosure in receipt of datastream 299 via network 250 as described above. As may be understood by those having ordinary skill in the art, one or more exemplary database 270b may be the primary recipient of comprehensive data, from e.g., user systems or devices 220-240, much of which may be relevant to transactions, information thereof, and other services performed by the company, which may be relevant to the overall performance and interests of the company as may be herein described. Such datastream 299 may be received via communications link 506a by exemplary database 270b, where it may be again transmitted via appropriate channels to accomplish such transactions and/or services. Exemplary database 270b may further feature comprehensive and/or sophisticated hardware and software installed thereon to perform the various tasks, analyses, data transformations, and computations as may be herein described and may in turn communicate the results thereof or receive instructions to perform such tasks to and/or from corporate systems C1-C3, and such communications may be accomplished via links 506b, 506c, and 506d, respectively. Additionally, certain other devices owned and/or authorized by the company to access, process, or otherwise perform tasks upon such data within datastream 299 may do so through private cloud 280, which may further be connected to exemplary database 270b, or alternatively through private and/or secure connections thereof via network 250. The above communications and computerized services environment as illustrated herein FIG. 2B, as well as those described above in relation to FIG. 2A, at least with respect to the disclosed systems and methods for geometric modeling of customer behavior and responses to marketing stimuli, its features and benefits, and potential implementations may be further understood by those having skill in the art from a review of the remaining Drawings, in addition to the accompanying detailed description.

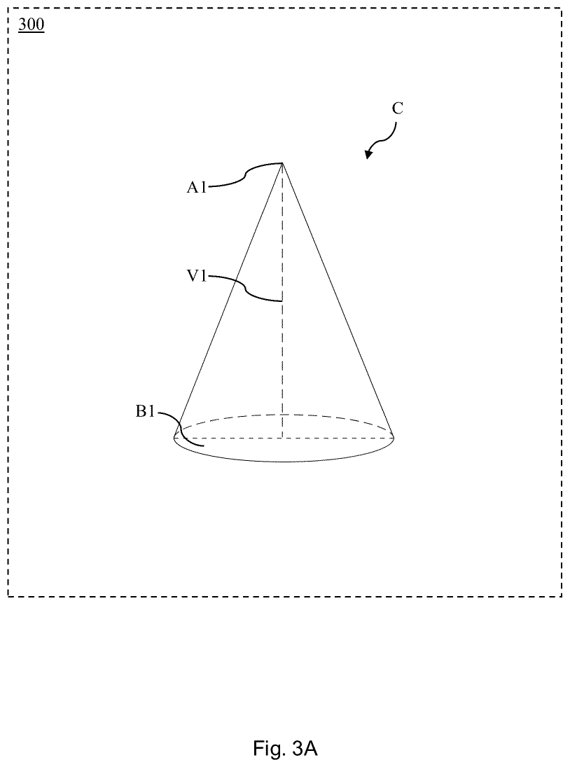

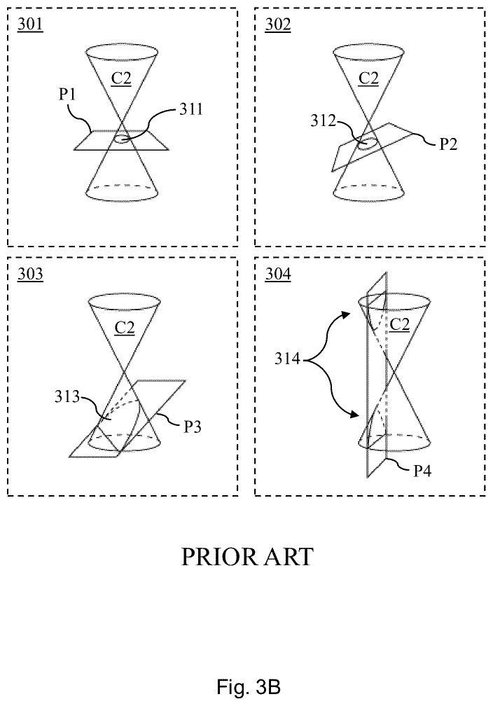

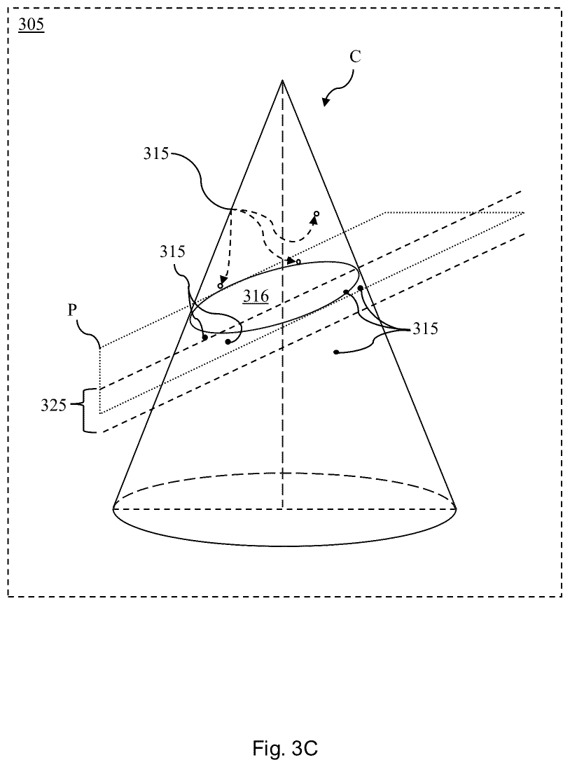

Turning to FIGS. 3A-D, generally they may provide illustrations of prior art geometric principles, the background of which may be additionally relevant to the disclosed data transformation systems and methods as described herein. Additionally, as it may relate to FIGS. 3A-D generally, insights may be gained into the initial modelling of such user behavior as may be herein described using such principles which, while informed by the prior art, may be novel features of the systems and methods for geometric modeling of customer behavior and responses to marketing stimuli. Beginning at FIG. 3A, therein illustrated is cone C in three-dimensional space 300 having apex A1, vertex V1, and base B1, as well as various features which may be recognized by those having ordinary skill in the art. FIG. 3A may be best understood as a fundamental illustration of cone C, wherein certain elementary geometric principles can be observed as they may be relevant certain various embodiments of the disclosed systems and methods for geometric modeling of customer behavior and responses to marketing stimuli. Cone C can be characterized by apex A1, which represents the highest point of the cone and coincides with the convergence of all generatrixes forming the surface of the cone. Vertex V1 may be understood as coinciding with apex A1 in this illustration but may also serve as a point of reference for more complex conical configurations in subsequent figures. Base B1 is illustrated as the circular boundary of cone C, defining the base plane upon which the generatrixes converge. This foundational illustration provides a geometrically simplified representation of a three-dimensional cone in a space, which may be constructed as affine space or in Euclidean space, as may be variously understood by those having ordinary skill in the art. As illustrated, the axis of symmetry for cone C may be represented as a central vertical line passing through apex A1 and base B1's center, enabling the symmetrical division of the cone into two equal halves. This axis serves as a fundamental reference for analyzing geometric interactions with cone C, such as the slicing planes and/or boundaries as may be further discussed in relation to FIGS. 3B-D. Furthermore, the generatrixes, while not explicitly labeled in FIG. 3A, may be conceptualized as the straight lines extending from A1 to the perimeter of B1, which collectively define the conical surface, two of which may be observed as slanted lines, which form the overall conic shape of cone C1, as illustrated. These principles may further establish a basis for understanding how cone C interacts with external geometric planes, as they are explored in greater detail in subsequent Drawings. The mathematical properties of cone C, such as its volume, surface area, and the geometric relationships between its dimensions, may also serve as a foundational framework for quantifying user behavior and marketing responses within the disclosed systems and methods. Additionally, certain user behaviors, which may be represented as points in space 300, on x/y axes of a chart, or in multi-dimensional space, which may be in turn mapped onto cone C in order to observe certain trends of a user, a cluster of users, or many users, including model functions, curves, shapes, or other geometric/algorithmic functions thereof which may be understood through digitization of such cone C in relation to such trends/behaviors in order to gain certain insights and/or perform experimental testing of hypotheses as may be further contemplated herein. While examples of such special features of cone C in relation to other mathematical and geometric principles are discussed herein, those having ordinary skill in the art may understand additional uses for cone modeling and digitization thereof, which are contemplated herein. These principles, in combination, can be used for various computations in affine and/or Euclidean space, as are further described in relation to the remaining Drawings, including by way of example and not limitation, FIGS. 3B-D.

Turning to FIG. 3B, illustrated therein are various known prior art geometric interactions between double-napped conical structure C2 (or double cone C2) and planar sections P1-4, demonstrating distinct sectional results at each interaction. As may be well understood by those having ordinary skill in the art of geometry, these configurations serve as a basis for describing the intersection properties and resultant geometric shapes formed by slicing double cone C2 with planes P1-4 at different angles and orientations. Based on these interactions between cones and planes, intersections of the planes' surface with that of the cones', those skilled in this art may understand the collection of such points of intersection can be mapped onto geometric curves and/or functions thereof. Similarly understood may be the formation of shapes formed by the planes' where they may intersect or “slice” the cones. Turning to first intersection 301, therein depicted is double cone C2 intersected by horizontal plane P1 passing symmetrically through the central vertical axis of the cone. The intersection forms circular cross-section 311 at the point where the plane meets the cone, or when intersecting the vertex (where each apex of double cone C2 meet) a point and/or apex/vertex may be understood. Second intersection 302 illustrates oblique angle plane P2, which may be any plane which is tilted at an oblique angle relative to the horizontal axis while intersecting double cone C2. The resultant intersection forms an elliptical cross-section 312 due to the angled orientation of the plane. Second intersection 302 demonstrates the geometric transition from a circular to an elliptical intersection as the plane deviates from a precisely horizontal orientation. Third intersection 303 introduces steep plane P3 that intersects double cone C2 at a steep angle relative to the vertical axis, creating parabolic cross-section 313. The orientation of steep plane P3 is such that it does not slice completely through both naps of the cone, thereby generating a single continuous curve characteristic of a parabola. The apex of the cone acts as a focal region for the parabolic section. As may be understood by those having ordinary skill in the art, a parabola may only be formed only when the plane is oriented parallel to exactly one generatrix, which is a straight line on the cone's surface extending from the vertex to the base. Hence, the curve formed is unbounded and open, with the plane intersecting at just the right angle to produce the parabolic cross-section 313. Turning finally to fourth intersection 304, vertical plane P4 intersects the double cone C2 parallel to its central axis, yielding hyperbolic cross-section 314. This intersection produces two distinct but continuous curves, highlighting the geometric properties of hyperbolas. When the intersecting plane passes through the apex of the cone (and accordingly its central axis), its vertical orientation ensures symmetrical division of the conical structure, but forms two intersecting lines, rather than hyperbolic cross-section 314. While vertical plane P4 may best demonstrate hyperbolic intersection formation, other planes which (a) intersect both naps of double cone C2, (b) do not cross the vertex thereof, (c) are not parallel to any generatrixes thereof, and (d) intersect thereof at an angle to the axis smaller than the cone's opening angle would form a hyperbola, which is understood as a type of smooth curve in geometry having the set of all points of a plane where the absolute difference of their distances from two fixed points (called foci) is a constant. In summary, the illustrations 301-4 may collectively represent the fundamental conic sections, which may include circles, ellipses, parabolas, and hyperbolas, and may be formed by varying the orientation of intersecting planes relative to cone C2. These visualizations may be essential for understanding the spatial properties and mathematical representations of conic sections, which may be foundational to numerous scientific and engineering endeavors, including those relevant to the instant systems and methods for geometric modeling of customer behavior and responses to marketing stimuli.

Turning now to FIG. 3C, illustrated therein is cone C interacting with plane P within three-dimensional geometric space 305. As illustrated, plane P intersects cone C at an oblique angle relative to both its central vertical axis and generatrixes, producing elliptical cross-section 316. As discussed above and throughout, the geometric properties of this interaction may provide further understanding of conic section principles and their application to modeling customer behavior in the disclosed systems and methods. The intersection of plane P with cone C generates elliptical cross-section 316 (having an outer circumference), which may be understood to have at its perimeter a bounded curve, which may be characterized as an ellipse, i.e., an elliptical shape having a bounded curve at its perimeter, i.e., circumference. The orientation of plane P may ensure that it slices through only one nap of cone C, as distinct from configurations that produce parabolic or hyperbolic sections, though understanding of the systems and methods for geometric modeling of customer behavior and responses to marketing stimuli may require understanding of both double-napped and single cones and the various geometric shapes and curves thereof such intersected planes. In the illustrated embodiment, the major and minor axes of elliptical cross-section 316 can be determined by the angle and orientation of plane P relative to the axis of symmetry of cone C. These axes may represent key parameters for defining geometric properties of the resultant ellipse, which can be further quantified using affine and/or Euclidean transformations or other mathematical tools. Additionally illustrated therein FIG. 3C may be plane P and its relationship to tolerance boundary area 325, having its own geometric properties, including orientation and spatial positioning, which can be defined relative to cone C. As illustrated on the surface (fronts are illustrated as solid dots and backs are illustrated as open dots) may be customer data points 315, which may be observed from certain user/customer interactions as may be described herein. As further illustrated in FIG. 3C, some points may fall within such tolerance boundary area 325 and be considered relevant to certain inquiries and/or hypothesis testing and some may be outside this boundary and be considered outliers to such inquiry/testing. As those having ordinary skill in the art may understand, tolerance boundary area 325 may be small or large, depending on a variety of factors, including but not limited to breadth of data, length of testing, testing population size, overall linear or functional relationship between/among variables, the like and/or combinations thereof. Additionally, plane P may form an elementary understanding of the disclosed systems and methods for geometric modeling of customer behavior and responses to marketing stimuli, but such relationship among variables may be more closely tracked with other geometric shapes/functions, such that they may be more closely modeled and/or tested using mechanisms to influence customer behavior as may be understood by those having ordinary skill in the art. The intersection curve of cross-section 316 may be described as a locus of points equidistant from two foci, consistent with the mathematical definition of an ellipse. By adjusting the angle or position of plane P, the dimensions and shape of cross-section 316 may vary, demonstrating the flexibility of this geometric framework in modeling diverse scenarios. As it relates to the disclosed systems and methods for geometric modeling of customer behavior and responses to marketing stimuli, plane P may be formed based on, among various other proposed and/or contemplated factors, business intentions (i.e., what marketing efforts may be designed to affect) or customer behavior. For example, the major and minor axes of elliptical cross-section 316 may be mapped to key performance indicators (KPIs) or other metrics in customer analytics. The orientation of plane P relative to cone C may correspond to external factors influencing customer behavior, such as marketing strategies, environmental variables, or demographic profiles. By systematically varying these parameters, the disclosed systems and methods may analyze, predict, and optimize customer engagement and marketing outcomes. As will be understood by those having ordinary skill in the art, elliptical cross-section 316 may represent one of several possible conic sections derivable from plane P's intersection with cone C. The mathematical and spatial properties of these sections, when applied within the disclosed systems, may serve as a foundation for advanced data transformations and behavioral modeling. As it may relate to planes specifically and mapping various points of its surface to a plane or vice versa, understanding of modelling a plane of best fit may be important to the understanding of systems and methods for geometric modeling of customer behavior and responses to marketing stimuli. Briefly, a plane of best fit, or plane P as it relates to mapping points on the surface of cone C illustrated herein FIG. 3C, can be described as a theoretical plane that minimizes the overall deviation between the plane itself and a set of data points distributed across the conical surface. This plane provides an optimal geometric reference for summarizing the spatial distribution of points and can be used to extract meaningful insights from the conical geometry. Plane P may then be determined by finding a plane that minimizes the sum of the squared perpendicular distances (or another appropriate error metric) from all given points on the conical surface to the plane. The result may be plane P that optimally approximates the distribution of the points, though FIG. 3C may not accurately portray such a plane and is not drawn to scale and provided is merely for illustration purposes. If the points are symmetrically distributed around the central axis of the cone, the plane of best fit is likely to be oriented parallel to the cone's base (a horizontal plane) and form a circle. However, since all “4 corners” of plane P would need to be exactly equidistant from the apex of cone C, such a plane may be unlikely when using real world data. If instead, the points are distributed asymmetrically or concentrated along certain regions of the cone, the plane may tilt at an angle that better reflects the spatial distribution of the points and form other geometric shapes and/or curves as are contemplated herein. The plane of best fit, as well as other geometric shapes which may intersect and/or “travel” along the surface of cone C, can be instrumental in geometric modeling and data analysis, particularly for systems and methods like those described herein. For instance behavioral mapping may be achieved by mapping customer behavior or response data onto the surface of a cone, and approximating the plane of best fit to act as a reference plane for aggregating or projecting multidimensional data and predicting future behavior and/or testing hypotheses. Optimization of such relationships between marketing efforts and effects may then be achieved through various orientation and position of the plane, which can reveal trends, outliers, or clusters in the data, guiding adjustments to marketing strategies or decision-making processes. Once established, the plane of best fit can then serve as a basis for further geometric or affine space transformations, enabling the application of analytical tools to the dataset. As it may relate to systems and methods for geometric modeling of customer behavior and responses to marketing stimuli specifically, customer activity may be plotted on cone C by apportioning out the current time spent on one or more marketing journeys when compared to a budgeted time, and then traversing the linear equivalent distance on corresponding cone C subject to reassessments at periodic intervals for deviations from a mark-up value on cone C as against actual current value(s) of the metric(s). The initially assigned curve, which may be the circumference/perimeter represented by cross section 316, may be retained for reference but periodic retrofits may be performed to see if any other curve better fits the ongoing/current behavior. Plane fitting algorithms of the disclosure may function by first obtaining a polygon in 3-dimensional space connecting all customer data points 315 marked on cone C, then identifying the highest and lowest points on the polygon, drawing a chord that connects the two points and using that as an axis for synthesizing various planes with a tolerance determined by the vertical distance between two vertically closest points on the polygon. More complicated and more simplified versions of such an algorithm may be selected by those having ordinary skill in the art in order to balance accurate modeling with recourse consumption (e.g., compute spend). Additional features, such as the focal points of intersecting shapes (e.g., ellipse, parabola) and their relation to the axis of cone C, may be utilized for more granular analyses in alternative embodiments of the disclosure.

Turning now to FIG. 3D, illustrated therein are various geometric configurations representing spiral and helical patterns on the surface of cone C within the three-dimensional spaces illustrated therein. The figures are divided into rows corresponding to different spiral structures (351a-c, 352a-c, and 353a-c), where each row demonstrates the transformation of a geometric spiral as it is projected, flattened, or visualized in different perspectives. These patterns may be relevant to modeling dynamic systems of customer behavior, where evolving parameters such as engagement, response, or spending may be abstractly represented by spiral trajectories. Generally, spaces marked “a” show exemplary complete helixes mapped onto a portion of a cone in 3-dimensional space, spaces marked “b” show exemplary flat 2-dimensional spiral corresponding to the helix of that row, and spaces marked “c” show portions of such helixes as they may be relevant to portions of customer journeys as may be described herein. As it may be relevant to representations 351a-c, or the first row therein FIG. 3D, each may be understood to represent helixes and spirals as they relate to cone C, the helixes and spirals of which may be a Fermat spiral. A Fermat spiral, also known as a parabolic spiral or Archimedean spiral of the second order, is a type of spiral that can be described mathematically by the polar equation r=±a\sqrt{θ} where “r” is the radial distance from the origin (or pole), “θ” is the angle in radians, and “a” is a scaling factor that determines the spiral's spread. Key features of a Fermat spiral include but may not be limited to symmetry about the origin, spiral shape that grows outward gradually, and applications to natural phenomena. For example, in nature, patters such as sunflower seeds and other phyllotactic structures may approximate this spiral. Geometrically, at least as it relates to simulating/describing natural and physical phenomena, the Fermat spiral approximates natural growth patterns because it allows even distribution of points around a center. In cartesian coordinates, the Fermat spiral can be expressed as x=\sqrt{θ} cos(θ), y=\sqrt{θ} sin(θ) where “x” and “y” are coordinates of points along the spiral. Visually, this spiral consists of a central point, or origin, from which two symmetrical branches extend outward, forming a smooth, sweeping pattern that maintains an even spacing between the arms as they expand outwardly. As may be appreciated by those having ordinary skill in the art, Fermat spiral 351b may fairly represent one of these symmetrical branches, though it may not be drawn to scale. Then, Fermat helix 351a and Fermat helix section 351c can be traced onto the surface of cone C by mapping this two-dimensional geometry onto the conical surface while maintaining its radial-angular relationship. Turning to the second row therein FIG. 3D, each may be understood to represent helixes and spirals as they relate to cone C, the helixes and spirals of which may be an Archimedean spiral. The Archimedean spiral, named after the ancient Greek mathematician Archimedes, is a type of spiral where the radial distance from the origin increases linearly with the angle. This creates evenly spaced turns that are consistent in their spacing, making it distinct from logarithmic or Fermat spirals. In polar coordinates, the Archimedean spiral is defined by r=a+bθ where “r” is again the radial distance from the origin, “θ” is again the angle in radians, “a” is now the initial radius and/or radial offset, and “b” is a constant that determines the spacing between successive turns (or rate of growth). As may be well understood by those having ordinary skill in the art, key characteristics of Archimedean spirals may include that the distance between successive turns is constant and equal to 2b, unlike logarithmic spirals where spacing increases exponentially, and symmetry about the origin. Known applications of this spiral include antenna design, natural geometric growth/shape patterns (e.g., shells and horns), engineering and robotics (e.g., pathfinding, surface coverage), and art/design uses based on aesthetics. In cartesian coordinates, the spiral can be expressed by x=(a+bθ) cos(θ), y=(a+bθ) sin(θ). Visually, as can be observed in Archimedean spiral 352b, The Archimedean spiral starts at a point near the origin (r=a) and expands outward in a smooth, evenly spaced curve. Its turns get progressively larger, but the distance between successive loops remains constant, though Archimedean spiral 352b may not be drawn precisely to scale. Then, Archimedean helix 352a and Archimedean helix section 352c can be traced onto the surface of cone C by mapping this two-dimensional geometry onto the conical surface while maintaining its radial-angular relationship. Turning to the third row therein FIG. 3D, each may be understood to represent helixes and spirals as they relate to cone C, the helixes and spirals of which may be a logarithmic spiral. A logarithmic spiral is a type of spiral that expands outward while maintaining a constant angle between the tangent to the spiral and the radial line from the origin. This property gives it a self-similar structure, meaning that the spiral appears identical at any level of magnification. In polar coordinates, the logarithmic spiral is described by r=ae^{bθ} where “r” is again the radial distance from the origin, “θ” is again the angle in radians, “a” is a scaling constant that determines the spiral's initial size, and “b” is a growth factor that controls how tightly (or loosely) the spiral winds. Key features of this spiral may include maintenance of a constant angle “α” between the tangent to the spiral and the radial line, self-similarity, infinite growth, and applications to nature and physics. Cartesian coordinates of the spiral can be expressed by x=r cos(θ)=ae^{bθ} cos(θ), y=r sin(θ)=ae^{bθ} sin(θ). Visually, the logarithmic spiral starts at a central point and grows outward, with each loop becoming progressively larger, as can be observed in logarithmic spiral 353b, though not drawn precisely to scale. Further observable therein logarithmic spiral 353b, despite the increasing size of the loops, the spiral never crosses itself and maintains its consistent shape. Then, logarithmic helix 353a and logarithmic helix section 353c can be traced onto the surface of cone C by mapping this two-dimensional geometry onto the conical surface while maintaining its radial-angular relationship. As may be appreciated by those having such skill, the columns “c” of FIG. 3D may be especially relevant to accurate modeling, hypothesis testing, algorithmic description of efforts/effects, and visualization thereof. These features, as well as basic considerations for such modeling of efforts/effects are described below, in light of these considerations, customer journeys, and relevant geometric features.

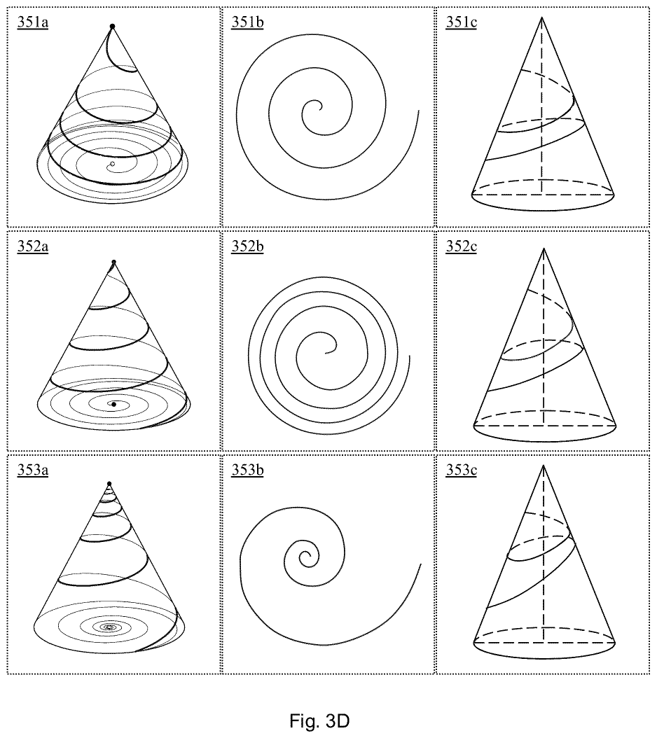

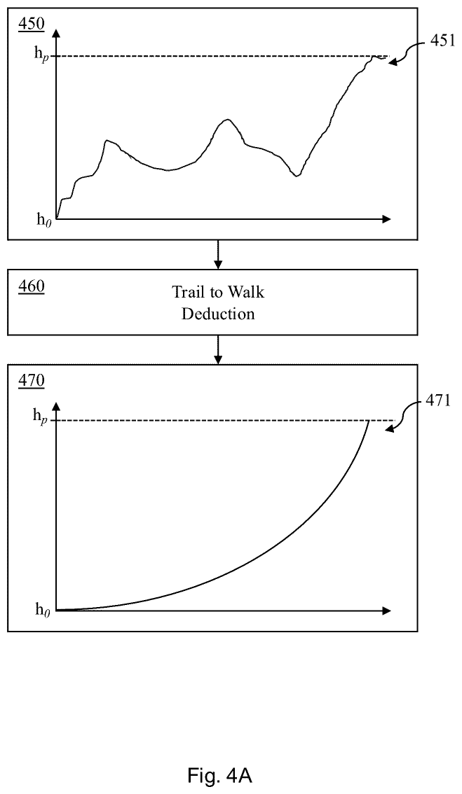

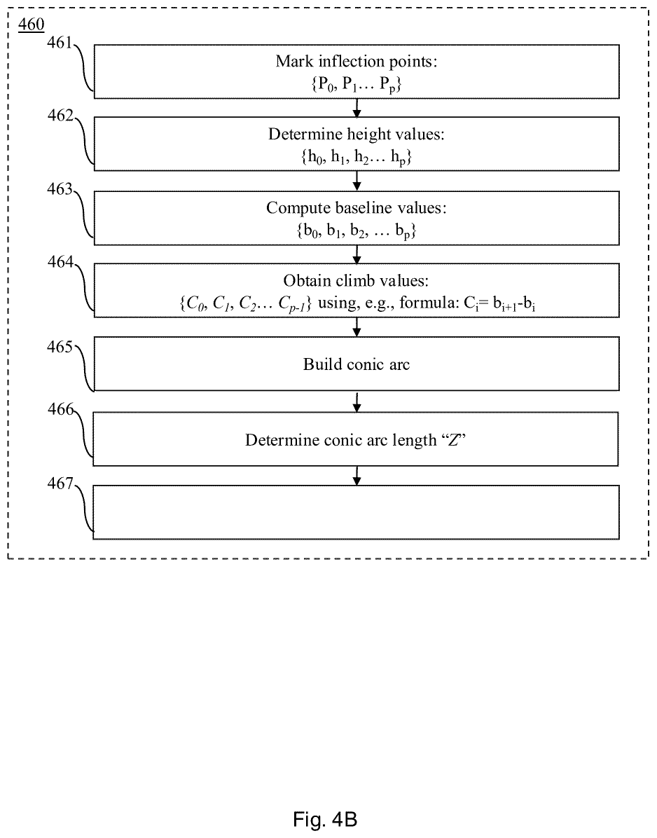

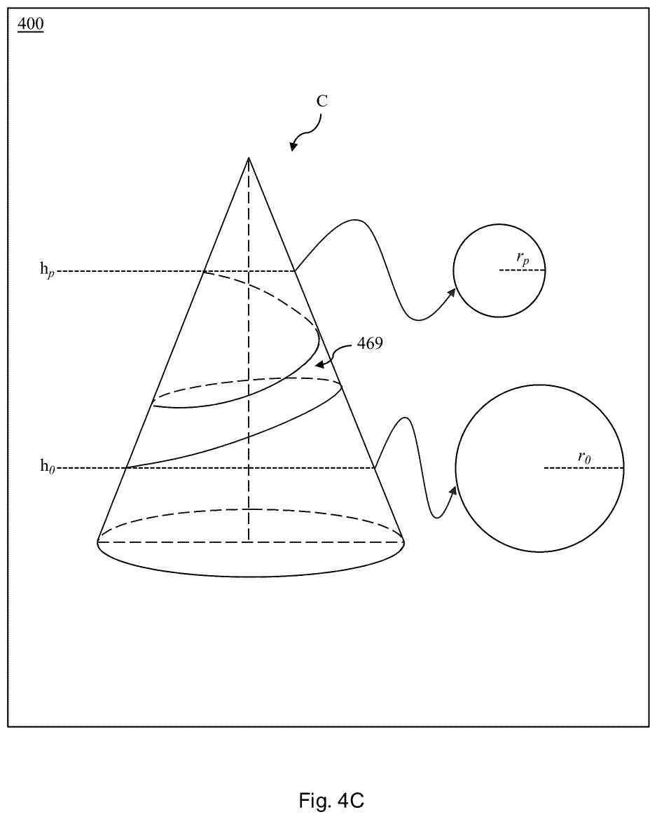

With respect to certain features of FIG. 4A, in broad terms, a customer's journey (or customer journeys at scale) can be modelled as smooth curves drawn on the surface of a cone with the apex denoting the goal, such as curve “Z”, which may have a shape, curve, length, associated function, the like and/or other features relevant to geometrically mapping marketing behavior and customer effects onto a conic surface according to principles which may be herein defined. As may be understood, such modeling may not require that any customers of any given curve Z actually reach the apex of cone Con any single curve approximated and/or formed, and customers may actually rise and fall along the height over time, but efforts may be made and/or prescribed by systems and methods of the disclosure to reach the apex, which may be some financial goal of the business as it relates to a customer, a cluster, the customer population, or variations thereof. Cones may be created for different objectives/goals between these efforts/effects as may be herein described, including but not limited to realizing a customer satisfaction value, selling to a specific Monthly Recurring Revenue (MRR), selling to a level of Assets Under Management (AUM), and/or goals/targets related thereto. On cone C “h” may be the height and “s” may be the effective walk length traversed along the surface of the cone. In a typical journey, customers might move both away and towards the apex, as a result of which “s” may not be what is actually traversed on the journey. Then, turning more specifically to FIG. 4A, an actual journey may be represented in chart 450, which may be understood as the “trail” (or customer trail 451) the customer takes from h₀, or the beginning of the trail, to hₚ, which may be the end of customer trail 451, at least with respect to the time under study. Then, turning briefly to FIG. 4B, customer trail 451, which may be classified therein FIG. 4B simply as “τ”, which may be quite longer than the straight-line and/or simple curve approximation thereof, may be observed in relation to chart 470. Turning to chart 470, a customer “walk” may be understood as the curve approximating customer trail 451, or customer walk 471, which may be classified herein FIG. 4A and referenced therein FIG. 4B as simply “w”. Understanding that by performing trail to walk synthesis/deduction, the customer journey can be approximated in order to better elucidate certain trends and/or simplify the overall understanding of the customer trail into a customer walk, steps 461-465 of FIG. 4B can be better understood by those having ordinary skill in the art, as is describe directly below.

Turning now to FIG. 4B, method 460 or deduction 460 of FIG. 4A, illustrated therein FIG. 4B may be a preferred embodiment of the trail-to-walk deduction algorithm involving steps 461-467 (and sub-steps thereof). Fundamentally with respect to method 460, at least two approaches may be formulated/performed to obtain the trail to walk deduction 460 of the disclosure: a time major approach and a traction major approach. In a time major approach, “τ” corresponding to a wall clock time of “x” days can be considered for partial walk synthesis. In a traction major approach, “τ” corresponding to a certain level of climb “y” can be instead considered for partial synthesis. Deduction/method 460 may begin at step 461 by first marking the inflection points of trail “τ”, which may be the points where direction flip occurs, either S2N (South to North) or N2S (North to South) to obtain points along walk 451 of, e.g., {P₀, P₁ . . . Pₚ}. Then, at step 462, “h” values for each inflection point, e.g., {h₀, h₁, h₂ . . . hₚ} can be determined corresponding to the heights observed thereof P values along trail 451. Then, at step 463, the baseline values, which may be the time elapsed since start (for time major approaches) or distance travelled/trail length from start (for traction major approaches) can be further computed (e.g., b₀, b₁, b₂, . . . bₚ). Further performing deduction/method 460, at step 464, climb values, e.g., {C₀, C₁, C₂ . . . Cₚ₋₁}, can be obtained using the formula Cᵢ=bᵢ₊₁−bᵢ, where the sign of Cᵢ is positive if Pᵢ is S2N and negative if Pᵢ is N2S in inflection, to obtain the series. Then at step 465, a series of checks are performed in order to build a conic arc. First, if the absolute value of “P” is less than a threshold, e.g., 3, over two inflection points, the path taken, which may be abbreviated as path “α”, may be 90°. If the peak is instead greater than this threshold, an “n” value may be selected according to the formula n=[ceil(0.1*|P|, 2] where the larger of two values are selected for “n” and the top “n” climb values for “C” are bound on absolute values of Cγ: {Cγ₁, Cγ₂, . . . Cγₙ}. Then, in those situations where such threshold is exceeded, path “α” can be obtained by the formula

$$α = {sin}^{- 1} \frac{Σ {C}_{γ}}{B}$$

where “B” is the total time in time major approaches and/or the total distance sampled in traction major approaches. At step 466, the length of conic arc “Z” can be obtained using the α value obtained at steps 465 and/or the algorithmic steps outlined above in relation thereto step 465, according to the formula Z=(r₀+r_{P} sin α)*2. Method 460 concludes at step 467 by establishing a conic arc of length Z covering 2 π radians, which can be drawn on cone C between points P₀ and Pₕ for the period under observation/prediction/prescription in order to both deduce the walk, based on the trail, and properly align such a walk on cone C.

Turning to FIG. 4C, an arbitrary example is provided in the description herein as may be relevant to a proposed cone C model of the systems and methods of the disclosure. If one assumes h₀ is the starting height along cone C and h_{P} is the ending point for any reason desired by one having ordinary skill in the art, and r₀=15 units and rₚ=6 units, Z may be obtained by Z=(r₀+r_{P} sin α)*2π, which translates to Z=(15+6 sin α)*2π. Now, assuming at step 455, E: {+10, −3, +4, +6}, meaning five points from origin, or |P|=5, step 465a yields n=(ceiling(0.1*5, 2) and maximum is obtained, to yield 2. Step 465b yields C₂={+10, +6} for the top two climb values and step 465c yields

$$α = {sin}^{- 1} \frac{16}{23} ,$$

or approximately 0.769 radians. Z can then be obtained at step 466 using the translated formula Z=(15+6 sin 0.769)*2π to obtain approximately 120.4 for the curve length for Z. Then, spiral arc 469 of length 120.4 units covering 2π radians on cone C from h₀ to hₚ, according to these and other principles as may be herein defined.

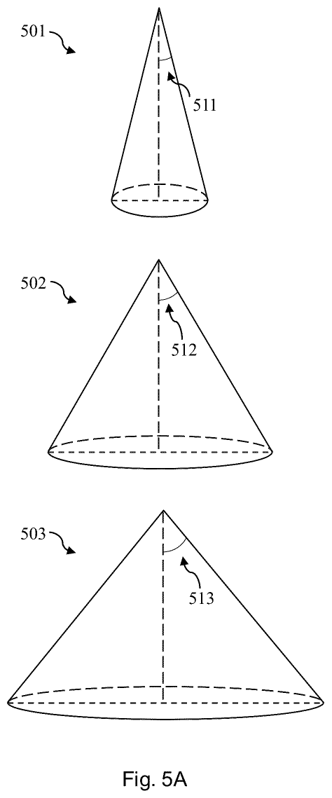

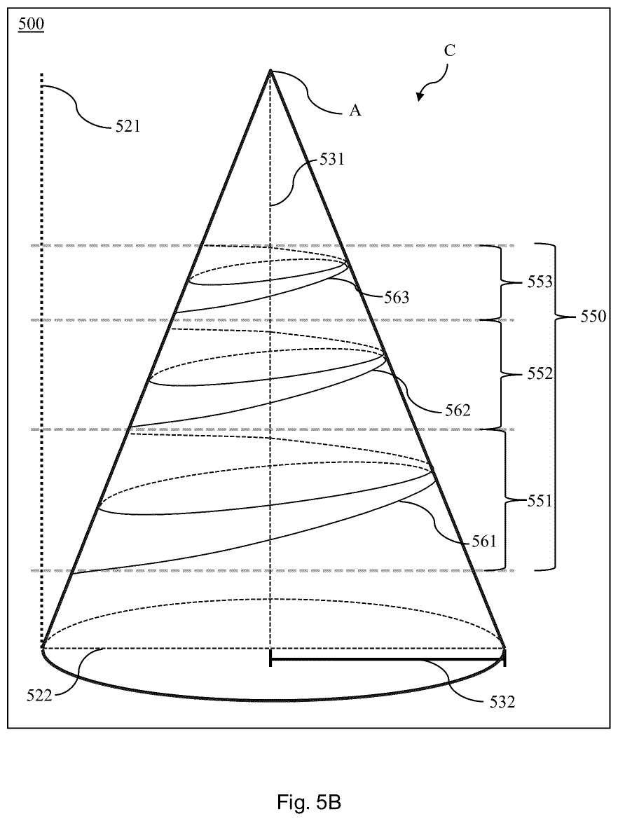

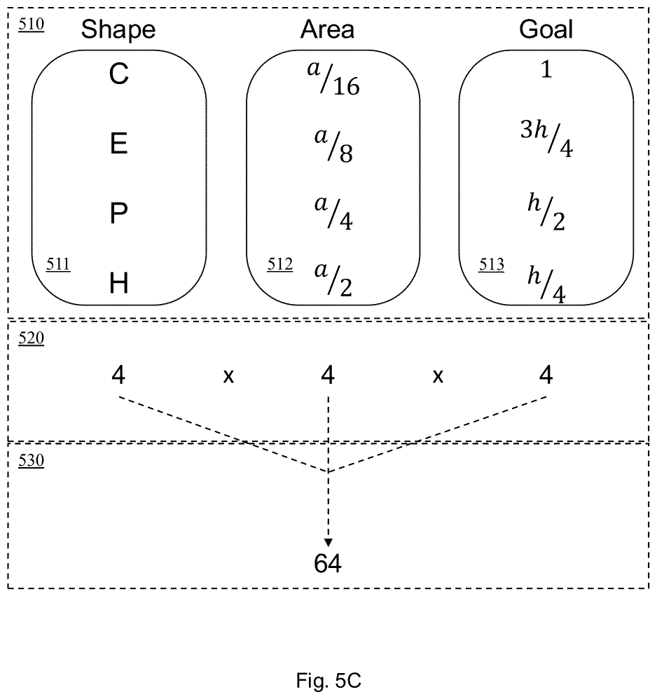

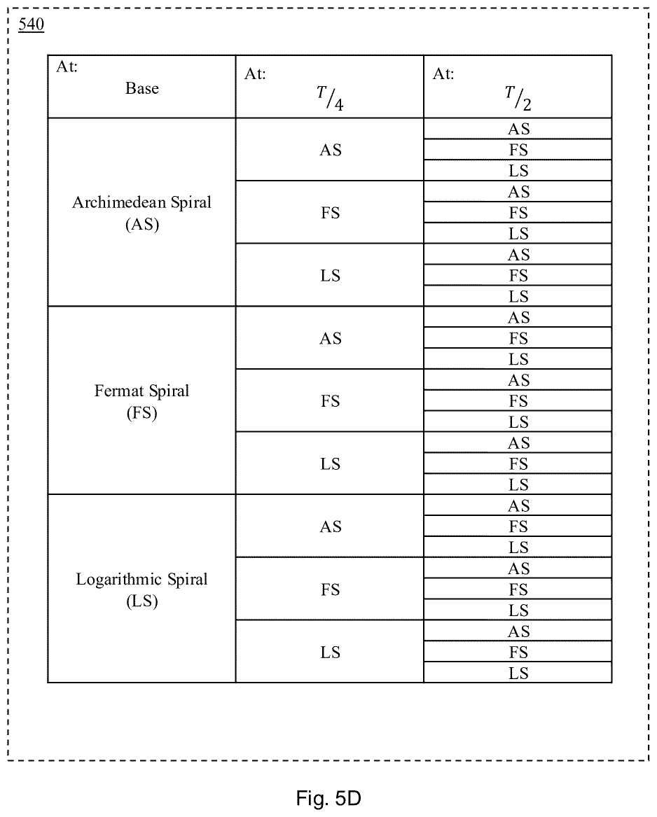

Turning to FIG. 5A, various features of the disclosed systems and methods for geometric modeling of customer behavior and responses to marketing stimuli can be better appreciated by those having ordinary skill in the art through review of various conical shapes of cone C, which may be varied based on various business objectives, customer types and/or hypothesis testing. Broadly, systems and methods of the disclosure can be used to map marketing journeys for customers according to at least the following considerations: (1) the leap, which may be the actual distance covered on cone C; (2) efforts, which may be α value associated with the marketing problem and efforts needed to solve them; and (3) customer behaviors, which may include certain assumptions and/or assignments of customer inclinations/behaviors. Considering these broad objectives and attempts to quantify them using geometric principles as herein described, height “h” may be always defined as it relates to an objective and/or goal for the business, or its leap, which may be further defined above. Such values may be based on various well-defined business and/or marketing metrics, including but not limited to assets under management (AUM) in financial settings, engagement index (EI) as it may relate to certain media consumption/interaction, and monthly recurring revenue (MRR) as it may relate to many consumer-driven products. As may be understood in the art, many quantitative measurements which may be readily captured, obtained, and/or calculated may be used and assigned as values of “h”. As discussed above, the conic spiral trajectory may essentially portray and/or model the customer's journey. As it relates then to efforts, these can be hypothesized taking natural odds and business conditions including larger marketing and competitive landscapes into consideration. Roughly, efforts may be understood as a measure of what the analyst or business employee/manager may optimally spend indirectly and budget to support the marketing journey. In certain systems of the disclosure, spiral curve 469 (see FIG. 4C) may then be defined as “s” in order to symbolize the efforts along the customer journey. Then with these principles in mind, as indicated from an overall observation of cones 501-503, it may be understood by those having ordinary skill in the art that as angles 511-513 become larger, the total efforts required to rise from any h₀ to any hₚ will be greater because spiral curve 469 would have to traverse a greater lateral/horizontal distance to rise in height, regardless of which spiral is chosen for the resulting helix/spiral curve 469. Such decisioning may then be useful to classify certain customers, then selecting among multiple cone C's (e.g., cones 501-503) in order to more precisely model and increase prediction fidelity in such a proposed system. As such, angles 511-513 may be selected from in order to determine a “θ” value as may be used herein. By way of example and not limitation, some customers may be “natural movers” or understood alternatively as very responsive in comparison to others. Accordingly, certain categories of customers who may be considered enthusiasts may be assigned θ values<30°, which may appear similar to narrow cone 501, laggards/idlers or those without eagerness toward the business offering(s) under consideration and/or overall may be assigned θ values>60° corresponding to wide cone 503, and those in between may have θ values therebetween as may be observed in moderate cone 502 (e.g., θ value(s) between 60° and 30°). Alternatively and/or concurrently, cones 501-503 may then be understood as enthusiast cone 501, generalist cone 502, and laggard cone 503, which may then be further differentiated by, for example, assigning θ values of 10° to enthusiasts, 50° for generalists, and 60° for laggards. Cutoffs for calculated θ may additionally be deployed in order to avoid outliers and/or simplify modeling. Then, additional terms may be understood to additionally classify customers/subscribers. These may include a marketing plane, which may be a plane horizontal to the base of any cone C and/or intersecting horizontally cone C along any height hᵢ, which may correspond to a circle Cᵢ with radius rᵢ in order to obtain, e.g., an apex, where r approaches or equals zero (0). Additionally, at least as it relates to various spiral types which may form a component of the disclosed systems and methods herein (see, e.g., FIG. 3D), the 4 quarters may symbolize and/or translate to concepts such as marketing inertia. In such embodiments of the disclosure, any point on the locus of marketing activity may take one of 4 values relevant to quadrants of cone C, e.g., Q1, Q2, Q3, Q4, which can be in turn based on and/or assigned by the efforts/effects trends, e.g., +/+, −/+, −/−, +/−, where positive trends on efforts would map to Q1 and Q4 and negative trends thereof to Q2 and Q3, and positive trends on effects would map to Q1 and Q2 with negative trends thereof to Q3 and Q4. Then, corresponding cone C may be synthesized indirectly from the spiral chosen in order to form the helix, with θ values of cone C chosen with respect to the spiral thereof. Then, To arrive at ‘θ’, all the customers may first be assigned, e.g., a Fair-AUM-Value and/or Fair-Engagement-Index, depending on what business users deem to be an average AUM/EI value for those customers regardless of the actual values. Then, all customers can be sorted sorted in the ratio of “actual AUM/EI” to “Fair AUM/EI” and given an ‘θ’ value, θᵢ=i/N where N is the total number of subscribers under study and the corresponding spiral can be selected. In such an additional embodiment of the disclosure, or in combination with others described herein, certain plane fitting may be obtained in order to perform the curve of best fit and other modeling techniques as may be relevant to the disclosure. Additional features of various cones 501-503, as well as spiral 569, which may also be assigned in various geometric formations based on quantitative observations, which may be better understood by those having ordinary skill in the art from description related thereto FIGS. 5B-C as well as the remaining Drawings.

Turning then to FIG. 5B, illustrated therein are exemplary marketing planes 500, which may be indicated in at least this exemplary embodiment by segments 550, including bottom segment 551 corresponding to spiral 561, middle segment 552 corresponding to spiral 562 and upper segment 553 corresponding to spiral 563. As may be appreciated by those having ordinary skill in the art, additional basic geometric properties of cone C having apex A may include axis 531, height measurement y-axis 521, base x axis 522 corresponding to radius 532. As discussed in relation to FIG. 5A directly above, cone C may be narrow, intermediate, or wide, which may indicate certain known, quantifiable user behavior profiles and increase overall length of spirals 561-563. Additionally, spirals 561-563 may be chosen, assigned, predicted, and/or prescribed by various understood spiral shapes, see, e.g., FIG. 3D. Given these fundamental features and combination thereof, additional features of mechanisms, methods, and schema of the disclosure are described in relation to FIGS. 5C-D directly below.

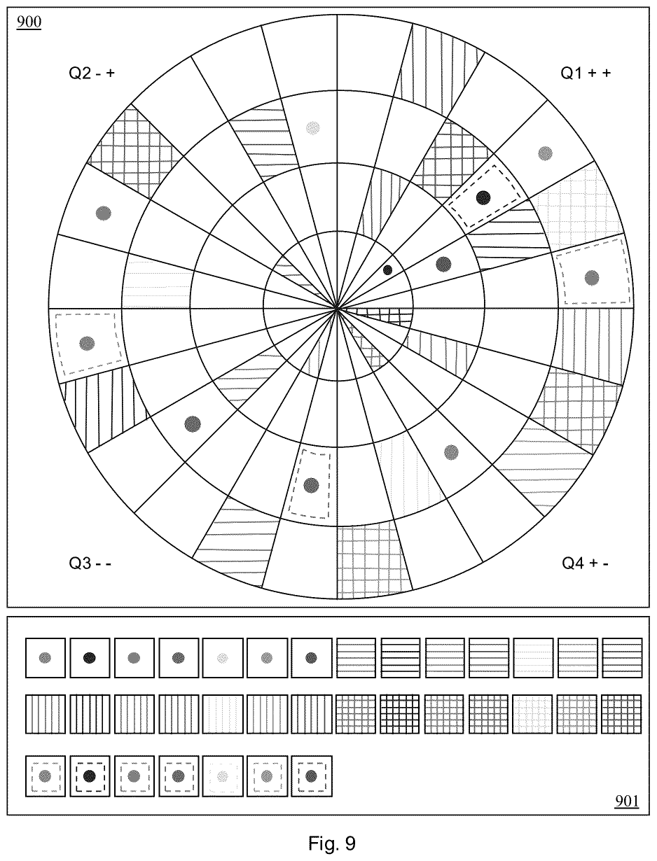

Turning to FIGS. 5C-D, which are discussed herein in combination, certain conics classification and clustering techniques are illustrated (FIG. 5C) as it may relate certain embodiment techniques to selection of spirals drawn upon cone C at various times on the journey (T of FIG. 5D). Beginning at initial clustering schema 510, shapes of curves (or approximations thereof) may be obtained using plane of best fit techniques as may be understood by those having ordinary skill in the art and/or as described herein to obtain, for instance, one of 4 shapes. These might include circles (C), ellipses (E), parabolas (P), and hyperbolas (H) as indicated in the leftmost box, which may be understood as shape classification 511. Turning to area classification 512, base areas of cone C may be classified into four clusters according to a/16, a/12, a/8, and a/2 as the bases become wider in descending order based on θ values obtained/assigned/clustered as may be described in greater detail above above. Then, progress toward goal classification can be classified according to segments and/or approximations thereof where 1 is the goal nearing completion and a lower number, e.g., h/4, is the greatest distance from goal where “h” corresponds to the height as may be described in greater detail above. Each classification 511-513 can then be said to have 4 possible combinations, represented by initial clustering 520, yielding a total of 64 possible combinations, which when understood in relation to FIG. 5D and other Drawings herein related to bitwise storage and/or memory modeling techniques, represented by final clustering 530, which may yield additional benefits in relation to efficient storage and/or computational costs of actually computing the clustering and performing the geometric constructions related thereto, which may be understood as. Turning to FIG. 5D, illustrated therein is exemplary spiral decisioning steps 540, which may form a basis for selecting the spiral to best approximate user behavior and influence thereof. As may be understood by those having ordinary skill in the art, at each step along a time series, the spiral selected may be switched to obtain plane-fitting to determine the plane that covers the majority of customer points plotted on cone C, and then use the conic section in conjunction swept-area(s) and height(s) covered to cover the 64 combinations in relation to potential spiral combinations. A decision tree may then be created from learning and/or attempts to understand user behaviors based on observed behaviors and recalibrations thereof as it may relate to any given subscribers' locus, conic shape/angle, peak height, or other geometric configurations described herein to form a knowledge base and better inform future decisioning and prediction in response to a marketing initiatives, hypothesis testing, and other predictions at any given point for different subscribers within the population being studied. A marketing activity hypothesis graphical user interface (GUI) can then be made available for business users where they may choose an audience, propose various marketing activities at various time intervals, add contextual decision variables and seek predictions from the geometric modeling on what the net effect of such an activity (i.e., effort) on the customers AUM or Engagement Index could be. Such proposed graphical user interfaces may include graphical codes, e.g., colorful coded art of FIG. 9. Such techniques to quantify, model, and output human-relevant and observable graphical patterns may then be understood to extrapolate these exemplary modeling frameworks by optimally synthesizing various helixes and/or conic spirals (e.g., AS, FS, LS) for any given subscriber or cluster thereof such that business users can effectively model and plan attempts to effectively traverse users from the base of any given cone C to apex A thereof with certain “pit-stops” or plane segments separating the strategies thereof, which can in turn emit proposed real world marketing activities that may have to be executed as a prescription to get the desired conic curve as the locus on any given cone C. Then, as it relates to the further modeling techniques related to these principles and others of the disclosed systems and methods for geometric modeling of customer behavior and responses to marketing stimuli, the remaining Drawings and description related thereto may further inform those having ordinary skill in the art to quantitatively model user behavior(s) related to business efforts using these geometric principles and data schema techniques as are further described below.

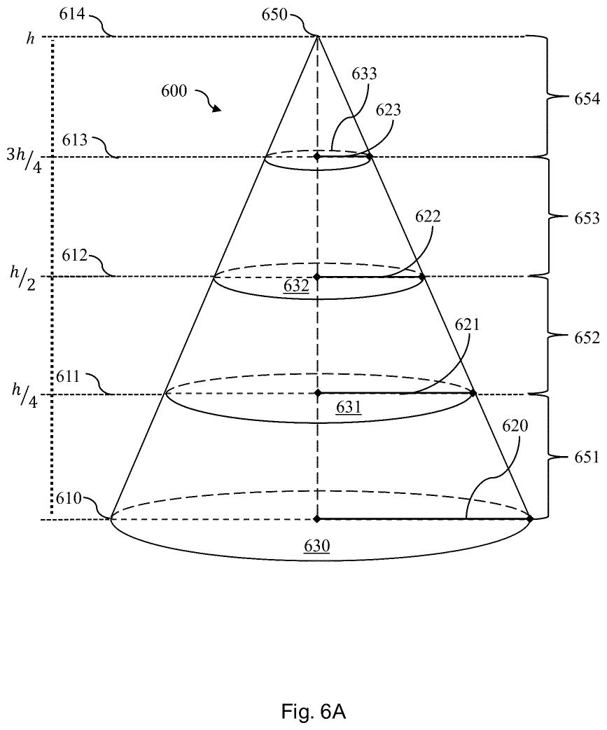

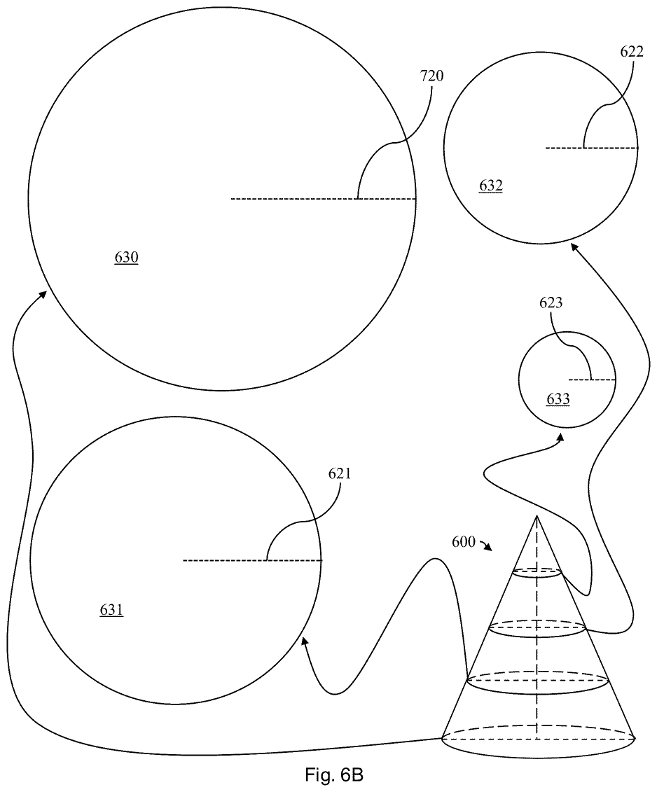

Turning to FIGS. 6A-B, illustrated therein are various segments of a proposed geometric construction of the disclosure as it may be relevant to further classification of the disclosed systems and methods for geometric modeling of customer behavior and responses to marketing stimuli. Beginning with FIG. 6, broadly, segments 651-654 of cone 600 may be formed of conic segments between circular planes 630-633 (having radii 620-623) and apex 650 (forming a point), which may correspond in turn to heights 610-614 as indicated along the y-axis thereof at certain fractional heights “h” of cone 600. Starting at base circular plane 630 and summer segment 651, which may end at h/4 circular plane 611, such a segment may be understood in a seasonal analogy to summer months, where enjoyment may be associated, based on new user experiences with new products/features, which can be studied while “spending” little in terms of efforts. Alternatively understood, these initial times may require additional efforts to raise any subscriber/customer to additional heights, without further understanding of behaviors and effects related to such efforts. Extending the analogy, winter segment 652, corresponding to the conic segment between circular plane 631 and circular plane 632, such a winter season may be understood to be a time of preparation but again with limited productive activity, which may be saved for seasons where weather is more kind to outdoor activities. Hence, this segment may require less efforts than summer to raise a customer's height due to efforts, and thoughtful planning may again be rewarded with sufficient study. In autumn segment 653, which may correspond to the period between circular plane 632 and circular plane 633, the analogy is again extended, though not sequentially from a typical seasonal perspective (i.e., winter, spring, summer, autumn, winter, etc.) but from that of activities and/or preparation that may occur during these months/seasons, in order to inform the systems and methods of the disclosure as to the selection of which spiral to select to best spend efforts to achieve greatest effects. As such, during autumn, temperatures may be more moderate and sufficient preparation for colder months may yield greater results during spring months. Finally, as apex 650 is approached in this analogy, spring segment 654 may be observed starting with circular plane 633 and rising to such apex 650. The flowering/growth and warming of such a season can be analogized to where efforts by well-informed business observers may pay its most observable dividends, flowering the relationship with the subscriber to obtain the target goal. In more concrete and/or quantifiable terms, segments 651-654 may instead and/or simultaneously correspond to trend quadrants described above in relation to FIG. 5A, including the positive/negative dichotomy as it relates to trends in efforts and effects and the modelling thereof. Then, turning to FIG. 6B, circular segments 630-633 having corresponding radii 620-633 can be obtained from cone 600 in order to further model such geometric features of the customer journey from a base to an apex of cone 600, in order to obtain the circular planes as they may be further relevant to additional mapping and modeling of effects and efforts.

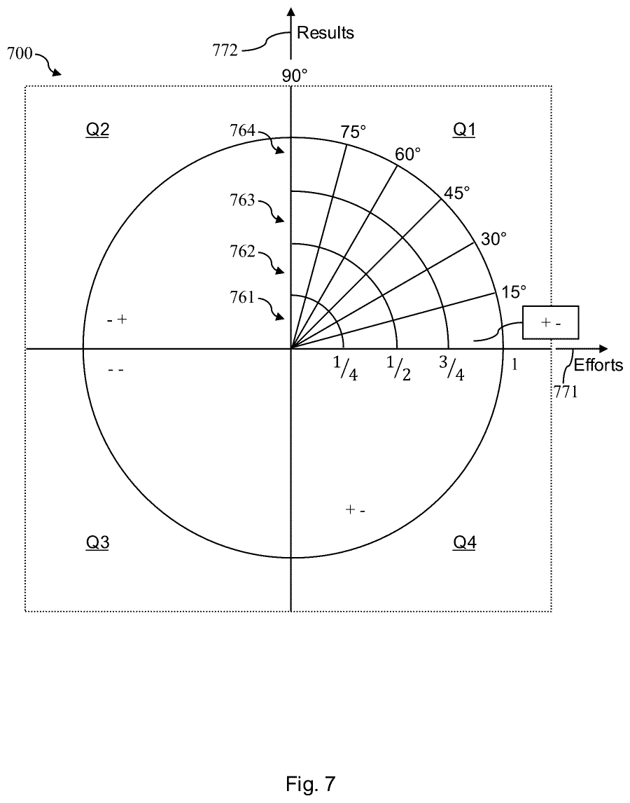

Turning to FIG. 7, one quadrant of exemplary marketing circle 700 as it may relate to FIGS. 6A-B and cone 600 thereof can be further described in relation thereto. As described above in relation to FIG. 5A, certain trends may indicate quadrants of any given circle of any given cone with respect to subscriber(s) and/or clusters thereof. Then, bands 761-764 may correspond to summer segment 651, which is depicted in detail herein FIG. 7. The four main sectors or segments 651-654 may then be translated into 4 quadrants, corresponding to the +/−trend dichotomy and seasonal analogies described in relation to FIGS. 5A and 6A, respectively. As indicated herein FIG. 7, bands or sectoral areas 761-764 may form at areas demarked by radial lengths 0, ¼, ½, ¾, and 1, respectively, and as indicated therein FIG. 7. Each band or sectoral area 761-764 may again be demarcated according to degree sections into 6 radials, e.g., between 0°-15°, 15°-30°, and so on as indicated therein FIG. 7, yielding a total of 24 sections per quadrant of exemplary marketing circle 700. Such bands thereof exemplary marketing circle 700 may in turn symbolize, e.g., where effects are grossly against expectations (band 761), where effects are generally in line with expectations (band 762), where effects are positively surprising (band 763) and where effects are exceptionally good (band 764), since as efforts 771 increase and results 772 increase, user loci may be quantitatively mapped to appropriate bands of the corresponding quadrant according to sequences based on time order and efficiently mapped to corresponding (non) transitory computer readable media of the disclosure as is further described directly below.

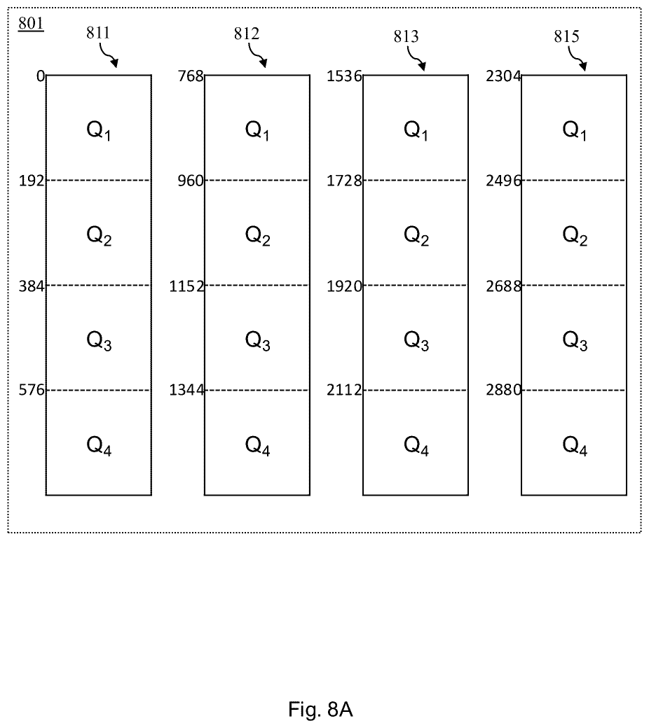

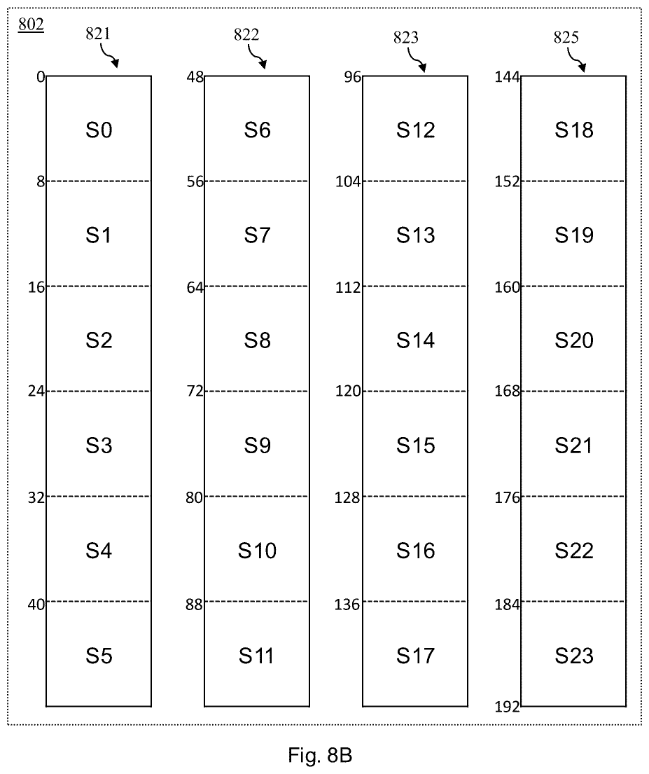

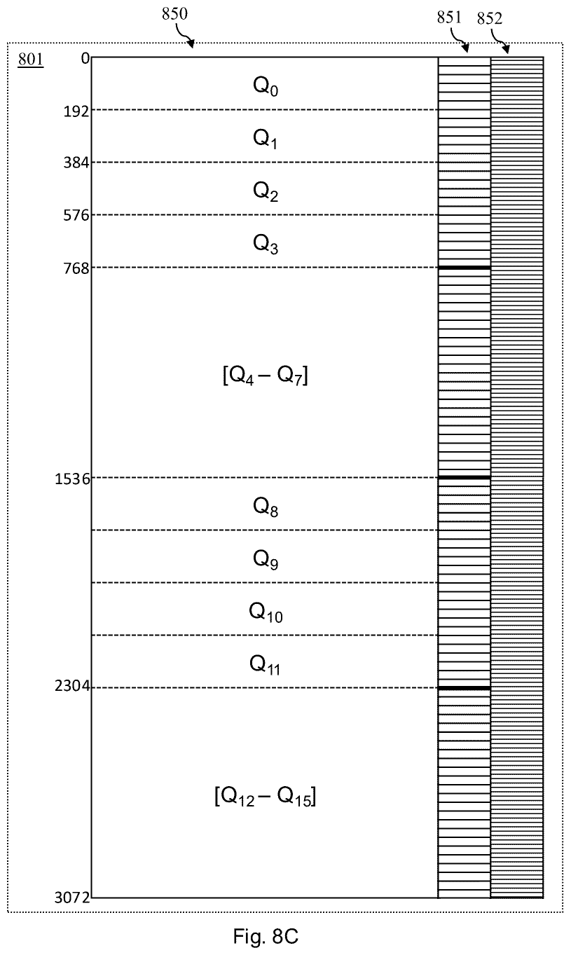

Turning to FIG. 8A, illustrated therein is an exemplary curve encoding schema 801 as it may relate to FIGS. 6A-B and provide further context to those having ordinary skill in the art. As such, segments 651-654 having corresponding bases 630-633, respectively and as illustrated therein FIGS. 6A-B, may further respectively correspond to pages 811-815 herein FIG. 8A in order to provide schema 801. As indicated, each page of 768 bytes may be separated into 4 sections each having 192 bytes in order to form a total of 3072 bytes for the winter, summer, autumn, spring cycle, as may be herein described and/or analogized. Alternatively described, each page of pages 811-815 may correspond to one of the circles therein FIGS. 6A, 6B and each page may further have four (4) blocks thereof, each referring to one of the four quadrants of said circles. Then, each block, shown as broken segments of pages 811-815, may further consist of, e.g., 24 sections under it, each section encoded using 8 bytes, via mechanisms known to those having ordinary skill in the art and as may be further described in relation to FIG. 8B. This many enable, in certain address spaces relevant to the disclosure, the ability to have every single section addressable using page, block, band, and individual section numbers on a per-subscriber basis, while only dedicating a total of 3,072 bytes to such an address space. Correspondingly, further elements of the disclosed systems and methods for geometric modeling of customer behavior and responses to marketing stimuli can be further structured and segmented in data arrangements, which may be optimized both spatially and for algorithmic lookup in order to minimize costs required to operate and interrogate the volume of data being collected at scale. These and other features of the disclosure may become apparent from review of the remaining Drawings and relevant written description.

Turning to FIG. 8B, illustrated therein may be an address space of single quadrant 802 of, e.g., pages 811-815, as may be indicated by Q1, Q2, etc. segmented along pages 811-815 therein FIG. 8A. Bands 821-825 may each contain serially sections S0-S23, as may be illustrated by the broken/dashed lines segmenting bands 821-825. Then, as indicated, it may be observed by those having ordinary skill in the art that each of sections S0-S23 (24 total sections) may be formed in 8-byte data arrangements, yielding the 192-byte page arrangement indicated in FIG. 8A for pages 811-815. Then as may be alternatively understood, pages 811-815 may be composed of 384 total 8-byte sections, each 8-byte section in turn associated with one of 4 quadrants of the 4 pages for 16 total 192-byte quadrants (which are each associated with a quadrant of circles as may be herein described) in order to form the entire subscriber address space of the disclosure. In the greater context of this arrangement, which may be appreciated by those having ordinary skill in the art, in the greater address space indicated in FIG. 8A, 3072 bytes may collectively represent four marketing circles of the disclosure as illustrated therein FIGS. 6-7. The quadrants can be named Q1-Q15 across the analogous “seasons” of summer-winter-autumn-spring, which are each a corresponding page of 811-815 of FIG. 8A, and may appear consecutively across the 4 quadrants as sᵢ through sᵢ₊₉₆ (i.e., indicated as S0-S24 extrapolated across the 4 quadrants to form each page), which results in the entire 3072 byte arrangement having a total section arrangement of s₀ through s₃₈₄ in order to provide direct access capabilities according to known methods and systems and methods of the disclosure, as may be understood by those having ordinary skill in the art via additional observation of FIG. 8C showing additional features of the 3072-byte arrangement, as well as the remaining Drawings and relevant description.

Turning to FIG. 8C, illustrated therein may be exemplary curve encoding schema 801 in an alternative illustrative view to highlight additional features of the proposed 3072-byte arrangement of the disclosure. Beginning at quadrants 850, quadrants Q₀ to Q₁₅ (16 quadrants) are segmented into 192-byte segments, with a page having quadrants Q₀ to Q₃ shown broken into its quadrants, a page having quadrants Q₄ to Q₇ shown grouped by its page, a page having quadrants Q₈ to Q₁₁ again shown broken into its quadrants, and finally a page having quadrants Q₀ to Q₁₅ again shown grouped by its page. These quadrants 850 are in turn broken into bands 851 on a 6-band per quadrant basis (though not drawn precisely to scale/numerosity therein bands 851) forming 96 bands in the 3072-byte arrangement, which may each contain 8-byte sections 852 for a total of 384 sections (which may be separated for illustration purposes only and not necessarily drawn to scale/numerosity) to enable the address lookup of the disclosure as well as direct access naming for recording efforts/effects as may be herein defined. So, for example, to obtain a direct address for read/write of sector 3 in band 2 of quadrant 1 of, e.g., spring page, the page address tables can be marked “0” for summer and correspond to page index 0, ‘1” for winter and correspond to page index 768, “2” for autumn and correspond to page index 1536, and “3” for spring and correspond to page index 2304, with quadrant indexes 0-3 corresponding to 0-, 192-, 384-, and 576-byte offsets, each having band indexes 0-3 having 0-, 48-, 96-, and 144-byte offsets to form the address of (Page No. offset)+(Quadrant No. offset)+(Band No. offset)+(Sector No.×8), or in the example above: Spring No. offset (2034)+Quadrant 1 offset (192)+band 2 offset (96)+sector 3×8 (24), which yields 2616, or the arithmetically obtained direct address for such an example. Then, as events, engagements, walks, and trails are defined and recorded, certain features of the disclosure can be further defined to obtain results, such as unique graphical user results and/or machine interpretable patterns and guides for business users, which are further explained in detail in relation to the remaining Drawings of the disclosure.

Turning to FIG. 9, illustrated therein is exemplary customer journey color artwork 900 (or “artwork 900”), which may provide human and machine readable and interpretable results using the conic formations of the disclosure in combination with the bitwise direct address arrangement of the resulting data thereof. Broadly, artwork 900, algorithms and direct address methods of the disclosure can “paint” the next pattern in an associated sector, as may be illustrated initially herein in relation to FIG. 7. Such patterns may be defined on a 3-trait basis, e.g., by one of 8 colors, one of 4 designs, and one of 3 borders, and the “painter” may move in the same manner as the binary tables as provided therein FIGS. 8A-C, such that the <8, 4, 3> triplet schema yields 96 corresponding possibilities for unique combinations of recorded behaviors/efforts in relation to any subscriber, which can provide more readily human-readable results in such a triple than a 7-bit number might provide. In other words, the machine can store and access by direct address using a 7-bit number and humans can observe such events/behaviors as they may share common features, such as same color (or similar color), same pattern (or related pattern), or same border (or similar border), in order to detect patterns related to an individual customer as well as provide means/mechanisms to observe commonalities among user clusters/types. In order to provide and/or paint any sector of exemplary customer journey artwork 900, the next number “n” in an event/time series is selected and considered in base-2 representation. The lower order 3 bits of b₂, b₁, and b₀ can be used to construct the color and interpreted as a binary number and assigned as “C” where the next 2 bits can correspond to the design number of b₄, b₃ can be used to assign the design number “D” and interpreted in binary. Then to obtain the border number in binary, the next 2 bits of b₆, b₅ can be indicated as “B”. Then, “n” may again be incremented to pick the color (e.g., 0—violet, 1—indigo, 2—blue, 3—green, 4—yellow, 5—orange, 6—red, 7—white, or as illustrated herein FIG. 9, e.g., 1—violet, 2—indigo, 3—blue, 4—green, 5—yellow, 6—orange, and 7—red, though other color schemas may suffice or be substituted as herein described), pick the design/pattern (e.g., 0—central dot, 1—horizontal stripes, 2—vertical stripes, and 3—hatch, as illustrated herein FIG. 9, though other pattern schemas may suffice or be substituted as herein described), and finally pick the border (e.g., 0—none, 1—dashed/dotted, 2—solid, though other border schemas may suffice or be substituted as herein described) via lookup functions on C, D, and B, respectively, yielding one sector of artwork 900 having a color, design and border as has been partially filled in therein FIG. 9. In an example of such a method of the disclosure, if n=0, in binary, this yields 00 00 000, yielding a violet dot without a border. Key 901 further illustrates such a binary key, where, e.g., n=1 may yield 00 00 001 in binary or an indigo dot without a border. Such artwork may be catalogued over the course of various events and separated by seasons to yield one “artwork” for each season or may be combined into artwork 900 to show progress through a journey and potentially reveal patterns/insights into such efforts/effects on a quantitative basis that may be more easily understood and interpreted by humans using the systems and methods of the disclosure. Key 901 may be used both to inform such a system for geometric modeling of customer behavior and responses to marketing stimuli and to enable those having ordinary skill in the art to interpret various customer behaviors on an individual, group, cluster, and/or global basis.

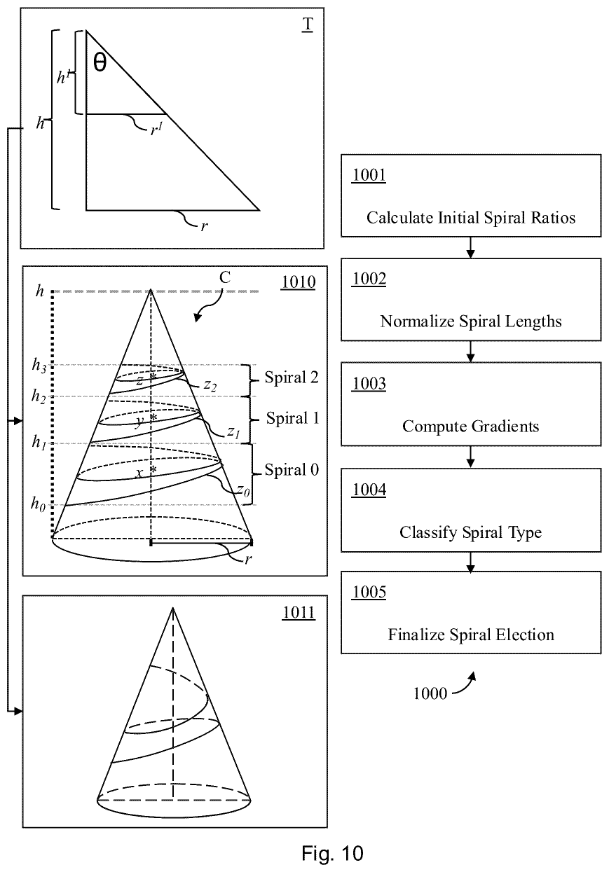

The above geometric representations of customer walks into customer trails, which may in turn be stored and accessed in bitwise address lookup techniques may then yield additional strategies to further harmonize these techniques into useful tools for marketing professionals to identify trends, test hypotheses, plan strategies, etc. in order to achieve certain goals as may be herein described. Turning to FIG. 10, therein illustrated is one such system and method, which may be understood as spiral electorate method 1000 in order to elect spirals 0-3 therein cone C of customer journey representation 1010 and determine single spiral of best fit 1011. Spiral electorate method 1000 may be understood here using 3 spirals of cone C, as may be described and illustrated in further detail in relation to FIG. 5B. Further relevant to spiral electorate method 1000 may be segmented triangle T, as illustrated herein FIG. 10. It may be a right triangle having height “h” of the larger triangle and “h¹” of the smaller upper segment, and as may be understood by those having ordinary skill in the art, it may consist of further segments in order to form cone C and segments thereof when geometrically constructed into a three-dimensional shape when spun. Then, in order to form such a triangle corresponding to at least two segments of cone C, “r” may be the base of the right triangle T and “r¹” may form any base of a segment thereof, which may in turn form the base of cone C when similarly geometrically constructed, such that certain trigonometry can be performed to obtain angles, curves, segments, loci, and other known geometric observations and quantifications thereof as are described in relation to spiral electorate method 1000. Then consider cone C having the additional annotated variables of h, z, r and points x, y, z annotated thereon in relation to spiral electorate method 1000 and three discreet spirals 0-1 where walk lengths z₀, z₁, z₂ correspond respectively thereto and are synthesized to reflect customer journeys between (h₀,h₁), (h₁,h₂), (h₂,h₃), also respectively, and “*” points x, y, z are the midpoints therebetween. Using basic trigonometric laws, such as tan

$$θ = \frac{r}{h} = {r}^{1} / {h}^{1} ,$$

and due to the cone's tapering structure, the circumference of circles drawn conically (i.e., parallel to the base) at x, y, and z may be radial lengths, e.g., U, V, and W, and be obtained as a ratio of any radii thereof any circle formed thereon such midpoints. If one skilled in the art were then to assume, based on these constructions and laws, that a smooth gradient “δ” at x, y, z, then circles as described herein may be elevated as spiral arms of lengths roughly to the earlier circumferences of the series. Additionally, one skilled in the art may also understand that the inherent bias at various heights can imply that the journey along the spiral, given the features and models thereof as described above, for a small vertical distance at any of x, y, and z may also be in the ratios of U:V:W, which may be evened out through corrections where at x, V/U is used, at z, V/W is used, and normalizing the spiral lengths with roughly the central spiral resting therebetween. Then, according to spiral electorate method 1000, at step 1001, α¹β¹γ¹ can be calculated using the following formulae:

$${α}^{1} = \frac{{z}_{0}}{{h}_{1} - {h}_{0}} ; {β}^{1} = \frac{{z}_{1}}{{h}_{2} - 1} ; {γ}^{1} = \frac{{z}_{3}}{{h}_{3} - {h}_{2}}$$

Continuing the method, corrections can be made at step 1002 by, for example, multiplying α¹ and γ¹ by the corresponding ratios of V/U and V/W, leaving β¹=β, to obtain corrected values of α, β, and γ, thereby normalizing the “z” spiral lengths with roughly the middle spiral residing between h₁ and h₂. At step 1003 of the method, gradients can be computed using the expression αγ/ß² and step 1004 can proceed. In exemplary embodiments of step 1004, a series of checks may be performed on values obtained. First, if the gradient obtained at step 1003 is between 0.8 and 1.2, an Archimedean spiral may be indicated for an angular distance of 4π radians between S and E¹. If instead, this value is greater than 1.2, a Fermat spiral may be indicated and if instead this value is less than 0.8, a logarithmic spiral may be indicated, each for a 4π radian period of the cone. To finalize the spiral electorate at step 1005, spirals 1-3, each having, for instance, angular distances of 31 radians can be replaced with 1 spiral arm of 4π radians.

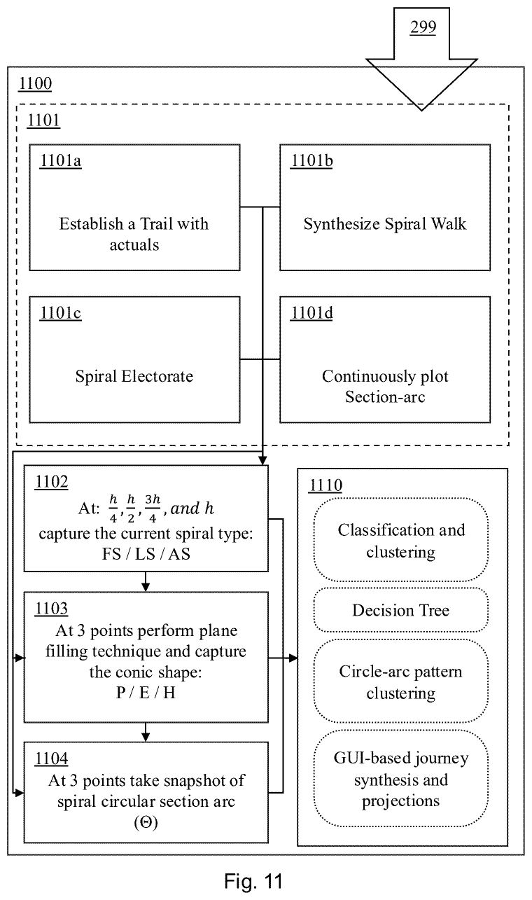

Having described basic computerized environment of systems and methods of the disclosure alongside certain geometric properties of cones and their cross-sectional curves and shapes (see, e.g., FIGS. 3A-C) as well as application of mapping certain other geometric formations (e.g., spirals of FIG. 3D) onto the surfaces of such cones, e.g., cone C, the basic fundamental features of the disclosed systems and methods for geometric modeling of customer behavior and various proposed schema thereof (see FIGS. 4-8 and 10), as well as a proposed GUI and/or customer visual representation to enable human and computerized understandings of certain behaviors and/or trends to enable certain hypothesis testing and/or marketing strategies (see, e.g., FIG. 9), responses to marketing stimuli can be further described in relation to the remaining Drawing, in order to provide a full understanding and appreciation of the application of these features to those having ordinary skill in the art. Concluding in this regard with FIG. 11, illustrated therein is multi-step method for geometric modeling of customer behavior and responses to marketing stimuli 1100, or simply method 1100. Method 1100 may involve, overall, the various systems and methods as herein disclosed in order to establish customer journeys, synthesize and/or digitize them in human and computer-readable and meaningful ways, and analyzing them to determine certain prescriptions and/or hypothesis testing. Beginning at datastream 299 (see FIGS. 2A-B), datastream 299 may involve the receipt of a continuous high-volume data that may be collected, organized, and curated based on customer/user interactions across various networks and devices, enabling their analysis, storage, and reporting to align customer journeys with business objectives. Further summarized, datastream 299 may represent continuously ingested and catalogued subscriber and/or subscriber-related events, actions, purchases, offers, etc. Using data obtained thereof datastream 299, initialization and data foundational parallel steps 1101 may be separated into the parallelly performed steps as herein described 1101a-d. Beginning with parallel processing step 1101a, a customer trail may be established via Trail-to-Walk deduction 460 of FIGS. 4A-B or may simply obtain chart 450 thereof. Overall, step 1101a may involve collecting and organizing data based on subscriber events, actions, and purchases. This customer trail can then serve as a foundation for subsequent analytical processes performed subsequently and/or parallel thereto such trail recording and/or walk deduction as is further described above in relation to FIG. 4A. Preferably parallel to step 1101a, step 1101b may synthesize spiral walks using various geometric and/or computational algorithms as are herein described. Specifically, at step 1101b, cone generational algorithms may be employed to generate the spiral walks, which may be based on and/or deduced from the customer trails and/or chart 450 as additionally described in relation to, e.g., FIGS. 4A-B and FIG. 5B, in order to analyze customer behavior in response(s) to stimuli. Additionally preferably parallel to step 1101a and/or step 1101b (and d), step 1101c may be performed to construct greater-span spirals, which may effectively represent subscriber activities in broader contexts, as may be more thoroughly described in relation to, e.g., FIG. 10. Finally preferably parallel to steps 1101a-c, step 1101d may be performed to continuously plot section arcs derived from various spiral representations of customer journeys according to the various systems, methods, and algorithms described in relation to, e.g., FIGS. 3A-D. Step 1101d may then ensure real-time tracking and updating of various customer journeys and their trajectories on any of the various cones C as may be herein described. Steps 1101a-d, then when performed in either parallel and/or separately, may be used to further perform steps 1102-4 as may be illustrated herein FIG. 11. Beginning arbitrarily at one of steps 1102-1104, step 1102 may be performed in order to determine and/or select the spiral type, which may include Fermat spiral (FS), logarithmic spiral (LS), and/or Archimedean spiral (AS), as further described in relation to spiral elections steps described in relation to FIG. 10, in order to most closely approximate and/or classify a particular journey of any given customer. As illustrated herein FIG. 11 and further described earlier in relation to FIG. 10, such spiral elections may occur arbitrarily at various points/heights of cone C, and h. Turing to step 1103, plane fitting and or may occur at/approximate,

$$e . g . , \frac{h}{4} , \frac{h}{2} , \frac{3 h}{4} ,$$

and h. Turning to step 1103, plane fitting and shape capturing may occur by selection of 3 points, which may be arbitrary and/or approximate

$$\frac{h}{4} , \frac{h}{2} , \frac{3 h}{4} ,$$

and h. Such planes may yield various shapes, as may further described in relation to prior art conic sections (see, e.g., FIG. 3B) and plane of best fit methods described in relation to, e.g., FIG. 3C. Such planes may have an angle in relation to the properties of cone C, which may then yield conic sections of, e.g., parabola (P), ellipse (E), and hyperbola (H). While those having ordinary skill in the art may further understand circles may also be yielded, given that out of the universe of possible planes intersecting a cone, circles are unlikely conic sections because the specific geometric conditions required for a plane to produce a circular conic section are highly restrictive. For a circle to form from a plane intersecting a cone, the intersecting plane must be precisely parallel to the base of the cone, as any deviation (even a slight tilt) will result in an ellipse instead of a circle. Furthermore, the plane must cut through the cone orthogonally to its axis of symmetry at the exact height where the cone's cross-section forms a perfect circle. This alignment may be exceedingly rare given the variability in plane angles and variability of customer data. Therefore, when considering the infinite orientations and positions of planes that could intersect a cone, only a small subset of those orientations would meet the strict conditions necessary for a circular conic section. Most intersections result in ellipses, parabolas, or hyperbolas, as they require less geometric precision, and ellipses, having geometric properties most similar to circles may be opted for instead in order to simplify the overall classification of planes and conic sections of best fit. Turning to step 1104, at each

$$\frac{h}{4} , \frac{h}{2} , \frac{3 h}{4} ,$$

and h height and/or customer sections of best fit. Turning to step 1104, at each journey point thereof, a snapshot of the spiral's circular section arc may be taken, such that further geometric data may be obtained in relation to any given customer's point on a journey toward a goal. Then, knowledge base utilization steps 1110 may be performed, using the above steps 1101a-c as well as steps 1102-4 performed therefrom. These include classification and clustering (see, e.g., FIG. 5C) in order to categorize customer patterns into distinct groups and/or clusters, decision tree analysis in order to predict the next outcome of various marketing activities (and test hypothesis(es) thereof), circle-arc patter clustering to group customer data based on similarities and/or shared patterns based on customer circular arc trajectories, and GUI-based journey synthesis projections toward any goal (i.e., cone C apex) in order to visualize the customer journey with projections toward the cone's apex and allowing marketing professionals to determine outcomes as, e.g., possible, likely, and/or unlikely, based on certain parameters and/or projection models as may be herein described.

With respect to the above description then, it is to be realized that the optimum methods, systems and their relationships, to include variations in systems, machines, size, materials, shape, form, position, function and manner of operation, assembly, order of operation, type of computing devices (mobile, server, desktop, etc.), type of network (LAN, WAN, internet, etc.), size and type of database and/or services provisioned, data-type stored therein databases, and uses thereof, are intended to be encompassed by the present disclosure.

In select embodiments, additional digital engagements, interactions, customer walks, customer journeys, micro-journeys and other events between brands and customers may be monitored in various forms, including but not limited to social media following/posts, email and SMS marketing (responses), online reviews across a plurality of online review platforms, chat/support interactions, purchases, subscriptions, referrals, @,” mentions, the download/installation/use of mobile apps and other software, the like and/or combinations thereof. Variation may exist among the described engagements and the weights/algorithms/maps assigned thereto. The subject matter of the disclosure is not limited to one particular industry, business type, website, social media platform, or entertainment platform, and the systems and methods disclosed herein are not limited in utility to social media, streaming platforms, review sites, app stores, support platforms and telecommunications device/service. Relevant sectors for use of the system and method of the disclosure may also include agriculture, forestry, fishing, banking, finance, residential/business telecommunications, mining, manufacturing, construction, hospitality education, arts, retail, utilities (e.g., electric, water, gas), healthcare, entertainment, broadcast media, other forms of social media not recited herein, the like and/or combinations thereof.

The foregoing description and drawings comprise illustrative embodiments of the present disclosure. Having thus described exemplary embodiments, it should be noted by those ordinarily skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments of the disclosure will come to mind to one ordinarily skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail, it should be understood that various changes, substitutions and alterations can be made thereto without departing from the spirit and scope of the disclosure as defined by the appended claims. Accordingly, the present disclosure is not limited to the specific embodiments illustrated herein, but is limited only by the following claims.

1. A computer-implemented method for modeling customer behavior and responses to marketing stimuli, the method comprising:
at a computing device having at least a processor, a memory, a network connection configured to transmit a plurality of customer-related data, and a non-transitory computer readable medium:
receiving, via said network connection, a data stream comprising said plurality of customer-related data and storing said plurality of customer-related data on at least one of said memory and said non-transitory computer readable medium;
constructing via the processor in receipt of said customer-related data via said network connection, a geometric representation of a plurality of customer journeys on a conical surface, wherein an apex of a cone corresponds to a predetermined business goal, and a conical surface is parameterized by a height (h) representing progress toward said predetermined business goal and a spiral path(s) representing a journey length corresponding to each of said plurality of customer journeys;
analyzing via the processor, in communication with at least one of the memory and the non-transitory computer-readable media, said plurality of customer journeys via the processor by detecting a plurality of inflection points along said plurality of customer journeys to segment each of said plurality of customer journeys into a plurality of discrete phases;
computing via the processor, in communication with at least one of the memory and the non-transitory computer-readable medium, a plurality of climb values and a plurality of baseline values corresponding to at least an effort metric and an effect metric for each of said plurality of discrete phases and storing said plurality of climb values and said plurality of baseline values on at least one of said memory and said non-transitory computer-readable medium; and
classifying via the processor, in communication with at least one of the memory and the non-transitory computer-readable medium, said plurality of discrete phases into an at least one conic section, said at least one conic section based on a plane of best fit corresponding to an intersection of said cone, said at least one conic section from a group of conic sections, the group consisting of an ellipse, a circle, a parabola, and a hyperbola.

2. The method of claim 1, further comprising selecting, via the processor, a selected spiral path for a customer journey of said plurality of customer journeys, said selected spiral path from a group of candidate spiral types, the group of candidate spiral types consisting of a Fermat spiral, an Archimedean spiral, and a logarithmic spiral, to obtain a selected spiral path.

3. The method of claim 2, wherein said selected spiral path is selected by the processor based on said at least one conic section and a predetermined threshold for marketing efforts and a predetermined threshold for marketing effects.

4. The method of claim 3, further comprising assigning, by the processor, a geometric parameter to said customer journey, said geometric parameter being a function of said selected spiral path, said at least one conic section, and a progress toward said goal.

5. The method of claim 4, further comprising storing, on one of said memory and said non-transitory computer-readable medium, by the processor, said geometric parameter and said customer journey in a structured data schema comprising a segmented plane type, an arc, and a plurality of points of the conical surface.

6. The method of claim 5, further comprising generating, by the processor in communication with at least one of the memory and the non-transitory computer-readable medium, a graphical representation of said customer journey on the conical surface, wherein said graphical representation includes visualized predictions of customer progress toward said apex and recommendations for an at least one marketing activity to optimize said customer journey based on said geometric parameter.

7. The method of claim 6, further comprising applying, via the processor in communication with at least one of the memory and the non-transitory computer-readable medium, an at least one reinforcement learning algorithm for said at least one marketing activity by iteratively updating said geometric parameter based on a historical data and a real-time customer-related data.

8. The method of claim 7, further comprising clustering, by the processor in communication with at least one of the memory and the non-transitory computer-readable medium, a plurality of customer journeys based on an identification of an at least one similarity said geometric parameter, said clustering used to identify a shared customer behavior pattern and generate a targeted marketing strategy.

9. The method of claim 8, further comprising recalibrating, via the processor in communication with at least one of the memory and the non-transitory computer-readable medium, said conical surface by adjusting an at least one parameter of the cone, including said height (h) and said spiral path(s), to reflect an at least one of an evolving business objective and a customer behavior trend.

10. The method of claim 3, further comprising generating, by the processor in communication with at least one of the memory and the non-transitory computer-readable medium, an interactive visual representation of the customer journey as customer journey artwork, wherein the artwork comprises a plurality of sectors on a conical section surface, each sector of said plurality of sectors is encoded with a combination of attributes, including a color, a pattern, and a border, said combination of attributes being derived from said selected spiral path(s), the at least one conic section, and a corresponding climb value of said plurality of climb values and a corresponding baseline value of said plurality of baseline values for each phase of said customer journey.

11. A computerized system for modeling customer behavior and responses to marketing stimuli, the system comprising:
a processor;
a memory;
a network connection configured to transmit and receive a plurality of customer-related data; and
a non-transitory computer-readable medium comprising instructions that, when executed by the processor, cause the system to:
receive, via the network connection, a data stream comprising said plurality of customer-related data and store said plurality of customer-related data in at least one of the memory and the non-transitory computer-readable medium;
construct, based on said customer-related data, a geometric representation of a plurality of customer journeys on a conical surface, wherein an apex of a cone corresponds to a predetermined business goal, and a conical surface is parameterized by a height (h) representing progress toward said predetermined business goal and a spiral path(s) representing a journey length corresponding to each of said plurality of customer journeys;
analyze said plurality of customer journeys by detecting a plurality of inflection points along said plurality of customer journeys to segment each customer journey into a plurality of discrete phases;
compute a plurality of climb values and a plurality of baseline values corresponding to at least an effort metric and an effect metric for each of said plurality of discrete phases and store said plurality of climb values and said plurality of baseline values in at least one of the memory and the non-transitory computer-readable medium; and
classify said plurality of discrete phases into at least one conic section, wherein said at least one conic section is based on a plane of best fit corresponding to an intersection of said cone, said at least one conic section selected from the group consisting of an ellipse, a circle, a parabola, and a hyperbola.

12. The system of claim 11, wherein the instructions further cause the processor to select a spiral path for a customer journey of said plurality of customer journeys, said spiral path being selected from a group of candidate spiral types, the group of candidate spiral types consisting of a Fermat spiral, an Archimedean spiral, and a logarithmic spiral.

13. The system of claim 12, wherein the selected spiral path is determined based on the at least one conic section and a predetermined threshold for marketing efforts and a predetermined threshold for marketing effects.

14. The system of claim 13, wherein the instructions further cause the processor to assign a geometric parameter to the customer journey, the geometric parameter being a function of the selected spiral path, the at least one conic section, and a progress toward the business goal.

15. The system of claim 14, wherein the instructions further cause the processor to store the geometric parameter and the customer journey in a structured data schema comprising a segmented plane type, an arc, and a plurality of points on the conical surface.

16. The system of claim 15, wherein the instructions further cause the processor to generate a graphical representation of the customer journey on the conical surface, the graphical representation including visualized predictions of customer progress toward the apex and recommendations for at least one marketing activity to optimize the customer journey based on the geometric parameter.

17. The system of claim 16, wherein the instructions further cause the processor to apply a reinforcement learning algorithm to iteratively update the geometric parameter based on historical data and real-time customer-related data.

18. The system of claim 17, wherein the instructions further cause the processor to cluster a plurality of customer journeys based on an identification of at least one similarity in the geometric parameter, the clustering used to identify shared customer behavior patterns and generate targeted marketing strategies.

19. The system of claim 18, wherein the instructions further cause the processor to recalibrate the conical surface by adjusting at least one parameter of the cone, including the height (h) and the spiral path(s), to reflect at least one of an evolving business objective and a customer behavior trend.

20. The system of claim 13, wherein the instructions further cause the processor to generate an interactive visual representation of the customer journey as customer journey artwork, wherein the artwork comprises a plurality of sectors on a conical section surface, each sector encoded with a combination of attributes, including a color, a pattern, and a border, the combination of attributes being derived from the selected spiral path, the at least one conic section, and a corresponding value at least one of said plurality of climb values and said plurality baseline values for each phase of the customer journey.
